(19) United States
(12) Patent Application Publication
(10) Pub. No.: US 2026/0006142 A1
(43) Pub. Date: Jan. 1, 2026

(54) Copy Detection Using Line Art Features and Encoded Signals

(71) Applicant: Digimarc Corporation, Beaverton, OR (US)

(72) Inventors: Tomas Filler, Beaverton, OR (US); Kristyn R. Falkenstern, Portland, OR (US); Adnan M. Alattar, Tigard, OR (US); Nicholas R. Anderson, Colorado Springs, CO (US)

(21) Appl. No.: 19/254,731

(22) Filed: Jun. 30, 2025

Related U.S. Application Data
(60) Provisional application No. 63/666,161, filed on Jun. 29, 2024.
(60) Provisional application No. 63/673,774, filed on Jul. 21, 2024.
(60) Provisional application No. 63/684,269, filed on Aug. 16, 2024.
(60) Provisional application No. 63/690,930, filed on Sep. 5, 2024.

(51) Int. Cl. H04N 1/00; H04N 1/32; H04N 1/52; H04N 1/58; H04N 1/62

(52) U.S. Cl. CPC H04N 1/00846; H04N 1/3232; H04N 1/52; H04N 1/58; H04N 1/626

(57) ABSTRACT

The present disclosure relates generally to signal encoding for value documents. One aspect of the technology relates to authentication of value documents comprising line art patterns. In one example, authentication relies of detection of signals encoded within the line art, and expected frequency domain analysis of the line art. Other combinations are described as well. For example, authentication may rely on detection of signals encoded within encoded and then printed documents, expected frequency domain characteristics encoded signals, presence or absence of halftoning, a color check and/or trained classifier analysis. Other aspects, technology, claims and combinations are described as well.

### RELATED APPLICATION DATA

This application claims the benefit of U.S. Provisional Application Nos. 63/690,930, filed Sep. 5, 2024, 63/684,269, filed Aug. 16, 2024, 63/673,774, filed Jul. 21, 2024, and 63/666,161, filed Jun. 29, 2024, each of which is incorporated herein by reference in its entirety.

### TECHNICAL FIELD

The present disclosure relates generally to advanced image signal processing involving signal encoding. One application of such technology is copy detection of printed objects.

### BACKGROUND AND SUMMARY

One form of signal encoding is digital watermarking. For purposes of this disclosure, the terms “digital watermark,” “watermark,” “data encoding” and “data hiding” are used interchangeably. We sometimes use the terms “encoding,” “encode,” “embedding,” “embed,” and “data hiding” to mean modulating (or transforming) data or physical surfaces to include information therein. For example, data encoding embeds an information signal (e.g., a plural bit payload or a modified version of such, e.g., a 2-D error corrected, spread spectrum signal) in a host signal. This can be accomplished, e.g., by modulating a host signal (e.g., image, video or audio) in some fashion to carry the information signal. The modulated signal can then be printed onto a surface or used to guide a relief forming process.

Some of Digimarc Corporation's work in signal encoding, data hiding, and digital watermarking is reflected, e.g., in U.S. Pat. Nos. 6,947,571; 6,912,295; 6,891,959; 6,763,123; 6,718,046; 6,614,914; 6,590,996; 6,408,082; 6,122,403; and 5,862,260, and in published specifications WO 9953428 and WO 0007356 (corresponding to U.S. Pat. Nos. 6,449,377 and 6,345,104). Each of these patent documents is hereby incorporated by reference herein in its entirety. Other digital watermarking technology is discussed below.

Additional aspects, features, combinations and technology will be readily apparent from the following description with reference to the accompanying drawings.

### BRIEF DESCRIPTION OF THE DRAWINGS

FIG. 1 is a block diagram of a signal encoder for encoding a digital payload signal into an image signal.

FIG. 2 is a block diagram of a compatible signal decoder for extracting the digital payload signal from an image signal.

FIG. 3 is a flow diagram illustrating operations of a signal generator.

FIG. 4 is a diagram illustrating embedding of an auxiliary signal into host image signal.

FIG. 5 is a flow diagram illustrating a method for decoding a payload signal from a host image signal.

FIG. 6 is a flow diagram illustrating operations of a signal generator.

FIG. 7 is a diagram illustrating a method of weighting elements of a raw data signal.

FIG. 8 shows a line 14 passing through a virtual grid of points.

FIG. 9 shows changes to width of the line of FIG. 8 to effect digital watermark encoding in a first arrangement.

FIG. 10 shows changes to a position of the line of FIG. 8 to effect watermark encoding in a second arrangement.

FIG. 11A shows a modulated line art pattern printed with a spot color.

FIG. 11B represents an optically captured greyscale version of the FIG. 11A modulated line art pattern.

FIG. 12 shows stages of an authentication process of a modulated line art pattern.

FIG. 13 shows an optically captured greyscale modulated line art pattern (FIG. 11B) and a CYMK reproduced copy, including Cyan and Yellow color planes.

FIG. 14 shows a 2D halftone arrangement of dots printed approximately 90-degrees with respect to horizontal rows and vertical columns.

FIG. 15 shows the authentication process of FIG. 12 but with an analysis of a copy.

FIGS. 16A-16D are screen shots from an authentication app operating on a mobile device.

FIG. 17A is a plot showing a relationship between Gloss Value percentages and varnish coverage for a matte varnish on an opaque white plastic substrate.

FIG. 17B is a scatterplot showing a Red-Green (RG) ratio vs. a Blue-Green (BG) ratio for pixel values.

FIG. 18 is a chart showing watermark detection rates for watermark signals carried by matte (right) and gloss (left) varnishes.

FIG. 19 is plot showing relationships of Gloss Value percentages and varnish coverage for a gloss varnish on an opaque white plastic substrate, particularly at a dot 3 with a 27% coverage rate.

FIG. 20 is a table showing different Gloss Value for different inks overprinted with matte varnish.

FIG. 21 shows a top row of printed ink, and a bottom row of the printed inks covered with a flood of matte varnish.

FIGS. 22A-24B show various different encoded signal arrangements.

FIG. 25A illustrates Table 1, with examples of tile sizes for different CPI and number of bit cells.

FIG. 25B illustrates Table 2, with examples of measured gloss contrast of a matte varnish.

FIG. 25C illustrates Table 3, with example data within a repository, indexable via a digital watermark payload.

FIG. 26 is a flow diagram for an authentication technology using frequency detection.

FIG. 27 illustrates one example of a so-called “binary mark” watermark at 150 cells per inch.

FIG. 28 is a plot of gloss contrast.

FIG. 29 shows different sparse marks printed with different ink.

FIG. 30 shows a sparse mark pattern printed with PMS 9520.

FIG. 31 shows sparse mark patterns with different dot or hole sizes.

FIG. 32 is a diagram of an image scanner.

FIG. 33 is a plot showing a relationship between captured scanner grey levels and Gloss Value percentages.

### DETAILED DESCRIPTION

### Introduction

The following detailed description is divided into five (5) general sections. It should be understood from the outset, however, that we expressly contemplate combining subject matter from one such section with one or more of the other sections. Thus, the sections and section headings are provided for the reader's convenience and are not intended to impose restrictions or limitations. The sections include: I. Signal Encoder and Decoder; II. Copy Detection Using Line Features and Encoded Signals; III. Digital Watermarking for Counterfeit Deterrence of Printed Objects; IV. Example Combinations of Features; and V. Operating Environments.

### I. Signal Encoder and Decoder

### Encoder/Decoder

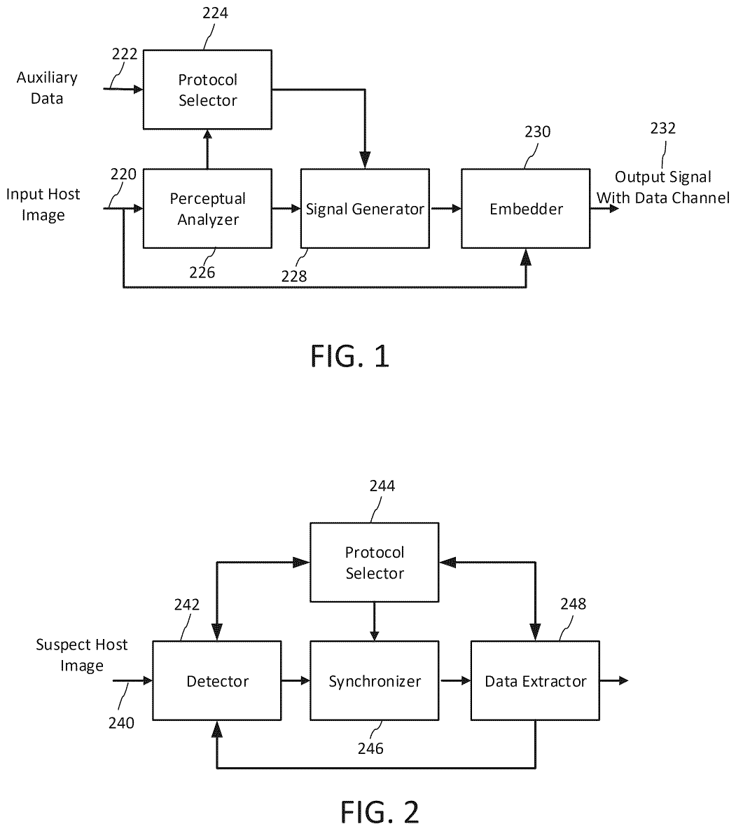

FIG. 1 is a block diagram of a signal encoder for encoding a digital payload signal into an image signal. FIG. 2 is a block diagram of a compatible signal decoder for extracting the digital payload signal from an image signal.

While the signal encoder and decoder may be used for communicating a data channel for many applications, one objective for use in physical objects is robust signal communication through images formed on and captured from these objects. Signal encoders and decoders, like those provided by Digimarc Corporation, Beaverton, Oregon, USA, communicate auxiliary data in a data carrier within image content. Encoding and decoding is applied digitally, yet the signal survives digital to analog transformation and analog to digital transformation. For example, the encoder generates a modulated digital image that is converted to a rendered form, such as a printed image. The modulated digital image includes the encoded signal prior to rendering. Prior to decoding, a receiving device has or communicates with an imager to capture the modulated signal, convert it to an electric signal, which is digitized and then processed by the FIG. 2 signal decoder.

Inputs to the signal encoder include a host image 220 and auxiliary data payload 222. The objectives of the encoder include encoding a robust signal with desired payload capacity per unit of host signal (e.g., a unit may include the spatial area of a two-dimensional tile within the host signal), while maintaining perceptual quality. In some cases, there may be very little variability or presence of a host signal. In this case, there is little host interference on the one hand, yet little host content in which to mask the presence of the data channel within an image. Some examples include a package design that is devoid of much image variability (e.g., a single, uniform color). See, e.g., U.S. Pat. No. 9,635,378, incorporated herein by reference in its entirety.

The auxiliary data payload 222 includes the variable data information to be conveyed in the data channel, possibly along with other protocol data used to facilitate the communication. The protocol of the auxiliary data encoding scheme comprises the format of the auxiliary data payload, error correction coding schemes, payload modulation methods (such as the carrier signal, spreading sequence, encoded payload scrambling or encryption key), signal structure (including mapping of modulated signal to embedding locations within a tile), error detection in payload (CRC, checksum, etc.), perceptual masking method, host signal insertion function (e.g., how auxiliary data signal is embedded in or otherwise combined with host image signal in a package or label design), and/or synchronization method and signals.

The protocol defines the way the signal is structured and encoded for robustness, perceptual quality and/or data capacity. For a particular application, there may be a single protocol, or more than one protocol, depending on application requirements. Examples of multiple protocols include cases where there are different versions of the channel, different channel types (e.g., several digital watermark layers within a host). Different versions may employ different robustness encoding techniques or different data capacity. Protocol selector module 224 determines the protocol to be used by the encoder for generating a data signal. It may be programmed to employ a particular protocol depending on the input variables, such as user control, application specific parameters, or derivation based on analysis of the host signal.

Perceptual analyzer module 226 analyzes the input host signal to determine parameters for controlling signal generation and embedding, as appropriate. It is not necessary in certain applications, while in others it may be used to select a protocol and/or modify signal generation and embedding operations. For example, when encoding in host color images that will be printed or displayed, the perceptual analyzer 256 is used to ascertain color content and masking capability of the host image. The output of this analysis, along with the rendering method (display or printing device) and rendered output form (e.g., ink and substrate) is used to control auxiliary signal encoding in particular color channels (e.g., one or more channels of process inks, Cyan, Magenta, Yellow, or Black (CMYK) or spot colors), perceptual models, and signal protocols to be used with those channels. Please see, e.g., the visibility and color model technology used in perceptual analysis in U.S. Pat. Nos. 7,352,878, 9,117,268, 9,380,186, 9,401,001 and 9,449,357, which are hereby incorporated by reference in their entirety.

The perceptual analyzer module 226 also computes a perceptual model, as appropriate, to be used in controlling the modulation of a data signal onto a data channel within image content as described below.

The signal encoder may comprise one or more trained network models (e.g., deep learning models utilizing convolutional neural networks (CNNs) and/or recurrent neural networks (RNNs)) optimize the embedding of a variable watermark payload in the host signal for robustness to attacks and perceptual quality. These trained network models are employed within the signal encoder to produce the modulated host, carrying the auxiliary data. The digital watermarking may occur as the digital asset is generated. For example, a payload can be inserted into a digital asset during artificial intelligence content generation (“Gen AI”). Machine trained encoders are further discussed, e.g., in assignee's U.S. Pat. Nos. 11,704,765 and 11,625,805, and in assignee's US Published application Nos. 20220270199 and 20210357690, each of which is hereby incorporated herein in its entirety.

The signal generator module 228 operates on the auxiliary data and generates a data signal according to the protocol. It may also employ information derived from the host signal, such as that provided by perceptual analyzer module 226, to generate the signal. For example, the selection of data code signal and pattern, the modulation function, and the amount of signal to apply at a given embedding location may be adapted depending on the perceptual analysis, and in particular on the perceptual model and perceptual mask that it generates. Please see below and the incorporated patent documents for additional aspects of this process.

Embedder module 230 takes the data signal and modulates it into an image by combining it with the host image. The combining operation may be an entirely digital signal processing operation, such as where the data signal modulates the host signal digitally, may be a mixed digital and analog process or may be purely an analog process (e.g., where rendered output images, with some signals being modulated data and others being host image content, such as the various layers of a package design file). As mentioned above, the embedder module (or encoder) may also comprise one or models, such as encoder, decoder, and generative adversarial network models trained using machine learning. The encoder may employ models, such as neural networks (e.g., convolutional neural networks) trained using adversarial machine learning to optimize perceptual quality and watermark robustness. Please see the above incorporated patent documents for additional aspects of this process.

There are a variety of different functions for combining the data and host in digital operations. One approach is to adjust the host signal value as a function of the corresponding data signal value at an embedding location, which is limited or controlled according to the perceptual model and a robustness model for that embedding location. The adjustment may be altering the host image by adding a scaled data signal or multiplying by a scale factor dictated by the data signal value corresponding to the embedding location, with weights or thresholds set on the amount of the adjustment according to the perceptual model, robustness model, and/or available dynamic range. The adjustment may also be altering by setting the modulated host signal to a particular level (e.g., quantization level) or moving it within a range or bin of allowable values that satisfy a perceptual quality or robustness constraint for the encoded data.

As detailed further below, the signal generator 228 produces a data signal with data elements that are mapped to embedding locations in an image tile. These data elements are modulated onto the host image at the embedding locations. A tile may include a pattern of embedding locations. The tile derives its name from the way in which it is repeated in contiguous blocks of a host signal, but it need not be arranged this way. In image-based encoders, we may use tiles in the form of a two-dimensional array (e.g., 128×128, 256×256, 512×512) of embedding locations. The embedding locations correspond to host signal samples at which an encoded signal element is embedded in an embedding domain, such as a spatial domain (e.g., pixels at a spatial resolution), frequency domain (frequency components at a frequency resolution), or some other feature space. We sometimes refer to an embedding location as a bit cell, referring to a unit of data (e.g., an encoded bit or chip element) encoded within a host signal at the location of the cell. Again, please see the documents incorporated herein for more information on variations for particular type of media.

The combining operation may include one or more iterations of adjustments to optimize the modulated host for perceptual quality or robustness constraints. One approach, for example, is to modulate the host image so that it satisfies a perceptual quality metric as determined by perceptual model (e.g., visibility model) for embedding locations across the signal. Another approach is to modulate the host image so that it satisfies a robustness metric across the signal. Yet another is to modulate the host image according to both the robustness metric and perceptual quality metric derived for each embedding location. The incorporated documents provide examples of these techniques. Below, we highlight a few examples. See, e.g., U.S. Pat. No. 9,449,357; and see also, U.S. Pat. Nos. 9,401,001 and 9,565,335, which are each hereby incorporated by reference in its entirety.

For color images, the perceptual analyzer generates a perceptual model that evaluates visibility of an adjustment to the host by the embedder and sets levels of controls to govern the adjustment (e.g., levels of adjustment per color direction, and per masking region). This may include evaluating the visibility of adjustments of the color at an embedding location (e.g., units of noticeable perceptual difference in color direction in terms of CIE Lab values), Contrast Sensitivity Function (CSF), spatial masking model (e.g., using techniques described by Watson in US Published Patent Application No. US 2006-0165311 A1, which is incorporated by reference herein in its entirety), etc. One way to approach the constraints per embedding location is to combine the data with the host at embedding locations and then analyze the difference between the encoded host with the original. The perceptual model then specifies whether an adjustment is noticeable based on the difference between a visibility threshold function computed for an embedding location and the change due to embedding at that location. The embedder then can change or limit the amount of adjustment per embedding location to satisfy the visibility threshold function. Of course, there are various ways to compute adjustments that satisfy a visibility threshold, with different sequence of operations. See, e.g., U.S. Pat. Nos. 7,352,878, 9,117,268, 9,380,186, 9,401,001 and 9,449,357, US A1, already incorporated herein.

The Embedder also computes a robustness model. The computing of a robustness model may include computing a detection metric for an embedding location or region of locations. The approach is to model how well the decoder will be able to recover the data signal at the location or region. This may include applying one or more decode operations and measurements of the decoded signal to determine how strong or reliable the extracted signal is. Reliability and strength may be measured by comparing the extracted signal with the known data signal. Below, we detail several decode operations that are candidates for detection metrics within the embedder. One example is an extraction filter which exploits a differential relationship to recover the data signal in the presence of noise and host signal interference. At this stage of encoding, the host interference is derivable by applying an extraction filter to the modulated host. The extraction filter models data signal extraction from the modulated host and assesses whether the differential relationship needed to extract the data signal reliably is maintained. If not, the modulation of the host is adjusted so that it is.

Detection metrics may be evaluated such as by measuring signal strength as a measure of correlation between the modulated host and variable or fixed data components in regions of the host or measuring strength as a measure of correlation between output of an extraction filter and variable or fixed data components. Depending on the strength measure at a location or region, the embedder changes the amount and location of host signal alteration to improve the correlation measure. These changes may be particularly tailored so as to establish relationships of the data signal within a particular tile, region in a tile or bit cell pattern of the modulated host. To do so, the embedder adjusts bit cells that violate the relationship so that the relationship needed to encode a bit (or M-ary symbol) value is satisfied and the thresholds for perceptibility are satisfied. Where robustness constraints are dominant, the embedder will exceed the perceptibility threshold where necessary to satisfy a desired robustness threshold.

The robustness model may also model distortion expected to be incurred by the modulated host, apply the distortion to the modulated host, and repeat the above process of measuring detection metrics and adjusting the amount of alterations so that the data signal will withstand the distortion. See, e.g., U.S. Pat. Nos. 9,380,186, 9,401,001 and 9,449,357 for image related processing.

This modulated host is then output as an output image signal 232, with a data channel encoded in it. The operation of combining also may occur in the analog realm where the data signal is transformed to a rendered form, such as a layer of ink or coating applied by a commercial press to substrate. Another example is a data signal that is overprinted as a layer of material, engraved in, or etched onto a substrate, where it may be mixed with other signals applied to the substrate by similar or other marking methods. In these cases, the embedder employs a predictive model of distortion and host signal interference and adjusts the data signal strength so that it will be recovered more reliably. The predictive modeling can be executed by a classifier that classifies types of noise sources or classes of host image and adapts signal strength and configuration of the data pattern to be more reliable to the classes of noise sources and host image signals that the encoded data signal is likely to be encounter or be combined with.

The output 232 from the Embedder signal typically incurs various forms of distortion through its distribution or use. For printed objects, this distortion occurs through rendering an image with the encoded signal in the printing process, and subsequent scanning back to a digital image via a camera or like image sensor.

Turning to FIG. 2, the signal decoder receives an encoded host signal 240 and operates on it with one or more processing stages to detect a data signal, synchronize it, and extract data.

The decoder is paired with an input device in which a sensor captures an analog form of the signal and an analog to digital converter converts it to a digital form for digital signal processing. Though aspects of the decoder may be implemented as analog components, e.g., such as preprocessing filters that seek to isolate or amplify the data channel relative to noise, much of the decoder is implemented as digital signal processing modules that implement the signal processing operations within a scanner. As noted, these modules can be implemented as software instructions executed within an image scanner or camera, an FPGA, or ASIC, etc.

The detector 242 is a signal processing module that detects presence of the data channel. The incoming signal is referred to as a suspect host because it may not have a data channel or may be so distorted as to render the data channel undetectable. The detector is in communication with a protocol selector 244 to get the protocols it uses to detect the data channel. It may be configured to detect multiple protocols, either by detecting a protocol in the suspect signal and/or inferring the protocol based on attributes of the host signal or other sensed context information. A portion of the data signal may have the purpose of indicating the protocol of another portion of the data signal. As such, the detector is shown as providing a protocol indicator signal back to the protocol selector 244.

The synchronizer module 246 synchronizes the incoming signal to enable data extraction. Synchronizing includes, for example, determining the distortion to the host signal and compensating for it. This process provides the location and arrangement of encoded data elements within the host signal.

The data extractor module 248 gets this location and arrangement and the corresponding protocol and demodulates a data signal from the host. The location and arrangement provide the locations of encoded data elements. The extractor obtains estimates of the encoded data elements and performs a series of signal decoding operations.

As detailed in examples below and in the incorporated documents, the detector, synchronizer and data extractor may share common operations, and in some cases may be combined. For example, the detector and synchronizer may be combined, as initial detection of a portion of the data signal used for synchronization indicates presence of a candidate data signal, and determination of the synchronization of that candidate data signal provides synchronization parameters that enable the data extractor to apply extraction filters at the correct orientation, scale and start location of a tile. Similarly, data extraction filters used within data extractors may also be used to detect portions of the data signal within the detector or synchronizer modules. The decoder architecture may be designed with a data flow in which common operations are re-used iteratively or may be organized in separate stages in pipelined digital logic circuits so that the host data flows efficiently through the pipeline of digital signal operations with minimal need to move partially processed versions of the host data to and from a shared memory unit, such as a RAM memory.

The decoder (or detector) may alternatively comprise one or more trained network models (e.g., deep learning models utilizing convolutional neural networks (CNNs) and/or recurrent neural networks (RNNs)) optimize the detection of a variable watermark payload in a host signal. These trained network models are employed within the signal detector to yield auxiliary data, despite the presence of noise, rotation, scaling, temporal shifts, scaling, etc. Machine trained decoders are further discussed, e.g., in assignee's U.S. Pat. Nos. 11,704,765 and 11,625,805, and in assignee's US Published application Nos. 20220270199 and 20210357690, each of which is hereby incorporated herein in its entirety.

### Signal Generator

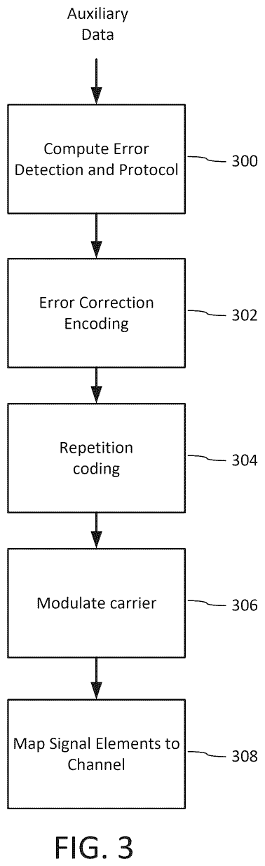

FIG. 3 is a flow diagram illustrating operations of a signal generator. Each of the blocks in the diagram depict processing modules that transform the input auxiliary data into a digital payload data signal structure. The input auxiliary data may include, e.g., a Global Trade Item Number (GTIN) developed by GS1. For example, the GTIN may be structured in the GTIN-12 format for UPC codes. Of course, the input auxiliary data may represent other plural bit codes as well. For a given protocol, each block provides one or more processing stage options selected according to the protocol. In processing module 300, the auxiliary data payload is processed to compute error detection bits, e.g., such as a Cyclic Redundancy Check (CRC), Parity, check sum or like error detection message symbols. Additional fixed and variable messages used in identifying the protocol and facilitating detection, such as synchronization signals may be added at this stage or subsequent stages.

Error correction encoding module 302 transforms the message symbols of the digital payload signal into an array of encoded message elements (e.g., binary or M-ary elements) using an error correction method. Examples include block codes, BCH, Reed Solomon, convolutional codes, turbo codes, etc.

Repetition encoding module 304 repeats and concatenates the string of symbols from the prior stage to improve robustness. For example, certain message symbols may be repeated at the same or different rates by mapping them to multiple locations within a unit area of the data channel (e.g., one unit area being a tile of bit cells, as described further below).

Repetition encoding may be removed and replaced entirely with error correction coding. For example, rather than applying convolutional encoding (1/3 rate) followed by repetition (repeating three times), these two can be replaced by convolution encoding to produce a coded payload with approximately the same length.

Next, carrier modulation module 306 takes message elements of the previous stage and modulates them onto corresponding carrier signals. For example, a carrier might be an array of pseudorandom signal elements, with equal number of positive and negative elements (e.g., 16, 32, 64 elements), or another waveform, such as sine wave or orthogonal array. In the case of positive and negative elements, the payload signal is a form of binary antipodal signal. It also may be formed into a ternary (of 3 levels, −1, 0, 1) or M-ary signal (of M levels). These carrier signals may be mapped to spatial domain locations or spatial frequency domain locations. Another example of carrier signals are sine waves, which are modulated using a modulation scheme like phase shifting, phase quantization, and/or on/off keying. In one embodiment, carrier modulation module XORs each bit of a scrambled signature with a string of 16 binary elements (a “spreading key”), yielding 16 “chips” having “0” and “1” values. If error correction encoding yields a signature of 1024 bits (which can then be randomized), then the carrier modulation module 306 produces 16,384 output chips.

Mapping module 308 maps signal elements of each modulated carrier signal to locations within the channel. In the case where a digital host signal is provided, the locations correspond to embedding locations within the host signal. The embedding locations may be in one or more coordinate system domains in which the host signal is represented within a memory of the signal encoder. The locations may correspond to regions in a spatial domain, temporal domain, frequency domain, or some other transform domain. Stated another way, the locations may correspond to a vector of host signal features, which are modulated to encode a data signal within the features.

Mapping module 308 also maps a synchronization signal to embedding locations within the host signal, for embodiments employing an explicit synchronization signal. An explicit synchronization signal is described further below.

To accurately recover the payload, the decoder extracts estimates of the coded bits at the embedding locations within each tile. This requires the decoder to synchronize the image under analysis to determine the embedding locations. For images, where the embedding locations are arranged in two dimensional blocks within a tile, the synchronizer determines rotation, scale and translation (origin) of each tile. This may also involve approximating the geometric distortion of the tile by an affine transformation that maps the embedded signal back to its original embedding locations.

In some case, the output of carrier modulation module 306 and/or mapping module 308 is used to generate a watermark signal that can be concatenated or combined with a host image or audio in a trained convolutional neural network (CNN) or recurrent neural networks (RNN) encoder model. These concatenated or combined host image or audio can be used as training input to such models. Different loss functions and optimization strategies can be employed during the training phase to achieve a desired performance, e.g., desired robustness against attacks (scaling, rotation, translation, cropping, etc.).

To facilitate synchronization, the auxiliary signal may include an explicit or implicit synchronization signal. An explicit synchronization signal is an auxiliary signal separate from the encoded payload that is embedded with the encoded payload, e.g., within the same tile). An implicit synchronization signal is a signal formed with the encoded payload, giving it structure that facilitates geometric/temporal synchronization. Examples of explicit and implicit synchronization signals are provided in U.S. Pat. Nos. 6,614,914, and 5,862,260, which are each hereby incorporated herein by reference in their entirety.

One example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference in its entirety.

U.S. Pat. No. 9,182,778, which is hereby incorporated by reference in its entirety, provides additional methods for detecting an embedded signal with this type of structure and recovering rotation, scale and translation from these methods.

Examples of implicit synchronization signals, and their use, are provided in U.S. Pat. Nos. 5,862,260, 6,614,914, 6,625,297, 7,072,490, 9,747,656, which are hereby incorporated by reference in their entirety.

Signal encoders and decoders may also employ network models trained to embed and extract the auxiliary data signal so as to be robust to geometric and temporal transformations, and thus, provide implicit synchronization. In these machine-learning based approaches, portions of the auxiliary data may function as a synchronization signal. Further, the features or encoding domains in which the models are trained to embed and extract the auxiliary data may be selected to be robust to anticipated forms of geometric or temporal transformation (e.g., spatial or temporal scale, rotation, or shift invariant feature sets).

### Signal Embedding In Host

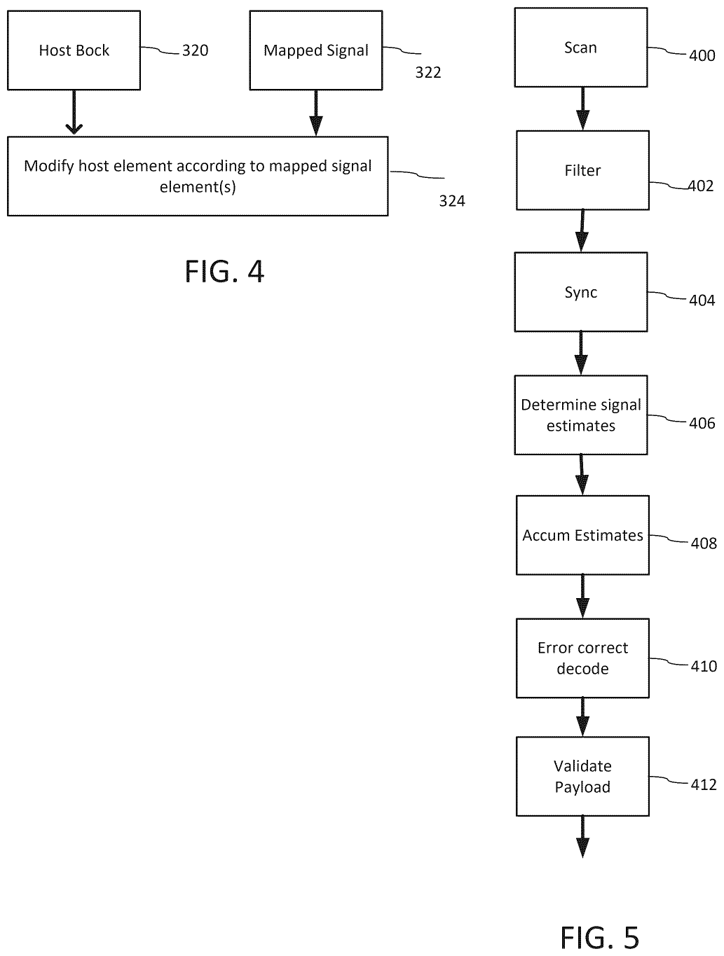

FIG. 4 is a diagram illustrating embedding of an auxiliary signal into host signal. As shown, the inputs are a host signal block (e.g., blocks of a host digital image) (320) and an encoded auxiliary signal (322), which is to be inserted into the signal block. The encoded auxiliary signal may include an explicit synchronization component, or the encoded payload may be formulated to provide an implicit synchronization signal. Processing block 324 is a routine of software instructions or equivalent digital logic configured to insert the mapped signal(s) into the host by adjusting the corresponding host signal sample(s) at an embedding location according to the value of the mapped signal element. For example, the mapped signal is added/subtracted from corresponding a sample value, with scale factor and threshold from the perceptual model or like mask controlling the adjustment amplitude. In implementations with an explicit synchronization signal, the encoded payload and synchronization signals may be combined and then added or added separately with separate mask coefficients to control the signal amplitude independently.

Following the construction of the payload, error correction coding is applied to the binary sequence. This implementation applies a convolutional coder at rate 1/4, which produces an encoded payload signal of 4096 bits. Each of these bits is modulated onto a binary antipodal, pseudorandom carrier sequence (−1, 1) of length 16, e.g., multiply or XOR the payload bit with the binary equivalent of chip elements in its carrier to yield 4096 modulated carriers, for a signal comprising 65,536 elements. These elements map to the 65,536 embedding locations in each of the 256 by 256 tiles.

An alternative embodiment, for robust encoding on packaging employs tiles of 128 by 128 embedding locations. Through convolutional coding of an input payload at rate 1/3 and subsequent repetition coding, an encoded payload of 1024 bits is generated. Each of these bits is modulated onto a similar carrier sequence of length 16, and the resulting 16,384 signal elements are mapped to the 16,384 embedding locations within the 128 by 128 tile.

There are several alternatives for mapping functions to map the encoded payload to embedding locations. In one, these elements have a pseudorandom mapping to the embedding locations. In another, they are mapped to bit cell patterns of differentially encoded bit cells as described in U.S. patent application Ser. No. 14/724,729 (issued as U.S. Pat. No. 7,747,656). In the latter, the tile size may be increased to accommodate the differential encoding of each encoded bit in a pattern of differential encoded bit cells, where the bit cells corresponding to embedding locations at a target resolution (e.g., 300 DPI).

U.S. Pat. No. 9,635,378 describes methods for inserting auxiliary signals in areas of package and label designs that have little host image variability. These methods are particularly useful for labels, including price change labels and fresh food labels. These signal encoding methods may be ported to the printing sub-system in scales used within fresh food, deli and meat departments to encode GTINs and control flags for variable weight items in the image of a label, which is then printed by the printer sub-system (typically a thermal printer) on the label and affixed to an item.

For an explicit synchronization signal, the mapping function maps a discrete digital image of the synchronization signal to the host image block. For example, where the synchronization signal comprises a set of Fourier magnitude peaks or sinusoids with pseudorandom phase, the synchronization signal is generated in the spatial domain in a block size coextensive with the 256 by 256 tile (or other tile size, e.g., 128 by 128) at target embedding resolution.

Various detailed examples of encoding protocols and processing stages of these protocols are provided in U.S. Pat. Nos. 6,614,914, 5,862,260, and 6,674,876, which are hereby incorporated by reference, and U.S. Pat. Nos. 9,117,268 and 9,635,378, previously incorporated. More background on signaling protocols, and schemes for managing compatibility among protocols, are provided in U.S. Pat. No. 7,412,072, which is hereby incorporated by reference.

One signaling approach, which is detailed in U.S. Pat. Nos. 6,614,914, and 5,862,260, is to map elements to pseudo-random locations within a channel defined by a domain of a host signal. See, e.g., FIG. 9 of U.S. Pat. No. 6,614,914. Elements of a watermark signal are assigned to pseudo-random embedding locations within an arrangement of sub-blocks within a block (referred to as a “tile”). The elements of this watermark signal correspond to error correction coded bits. These bits are modulated onto a pseudo-random carrier to produce watermark signal elements (block 306 of FIG. 3), which in turn, are assigned to the pseudorandom embedding locations within the sub-blocks (block 308 of FIG. 3). An embedder module modulates this signal onto a host signal by increasing or decreasing host signal values at these locations for each error correction coded bit according to the values of the corresponding elements of the modulated carrier signal for that bit.

FIG. 5 is a flow diagram illustrating a method for decoding a payload signal from a host image signal. The frames are captured at a resolution preferably near the resolution at which the auxiliary signal has been encoded within the original image (e.g., 300 DPI, 100 DPI, etc.). An image up-sampling or down-sampling operation may be performed to convert the image frames supplied by the imager to a target resolution for further decoding.

The resulting image blocks supplied to the decoder from these frames may potentially include an image with the payload. At least some number of tiles of encoded signal may be captured within the field of view, if an object with encoded data is being scanned. Otherwise, no encoded tiles will be present. The objective, therefore, is to determine as efficiently as possible whether encoded tiles are present.

In the initial processing of the decoding method, it is advantageous to select frames and blocks within frames that have image content that are most likely to contain the encoded payload. From the image passed to the decoder, the decoder selects image blocks for further analysis. The block size of these blocks is set large enough to span substantially all of a complete tile of encoded payload signal, and preferably a cluster of neighboring tiles. However, because the distance from the camera may vary, the spatial scale of the encoded signal is likely to vary from its scale at the time of encoding. This spatial scale distortion is further addressed in the synchronization process.

For more on block selection, please see U.S. Pat. No. 9,521,291, which is hereby incorporated by reference.

Please also see U.S. Pat. No. 9,922,220, which is hereby incorporated by reference, for more on block selection where processing time is more limited.

The first stage of the decoding process filters the image to prepare it for detection and synchronization of the encoded signal (402). The decoding process sub-divides the image into blocks and selects blocks for further decoding operations. For color images, a first filtering stage converts the input color image signal (e.g., RGB values) to a color channel or channels where the auxiliary signal has been encoded. See, e.g., U.S. Pat. No. 9,117,268, which is hereby incorporated herein by reference in its entirety, for more on color channel encoding and decoding. For an image captured under red illumination by a monochrome scanner, the decoding process operates on this “red” channel sensed by the scanner. Some scanners may pulse LEDs of different colors to obtain plural color or spectral samples per pixel as described in U.S. Pat. No. 9,749,607, which is hereby incorporated by reference.

A second filtering operation isolates the auxiliary signal from the host image. Pre-filtering is adapted for the auxiliary signal encoding format, including the type of synchronization employed. For example, where an explicit synchronization signal is used, pre-filtering is adapted to isolate the explicit synchronization signal for the synchronization process.

In some embodiments, the synchronization signal is a collection of peaks in the Fourier domain. Prior to conversion to the Fourier domain, the image blocks are pre-filtered. See, e.g., LaPlacian pre-filter in U.S. Pat. No. 6,614,914. A window function is applied to the blocks and then a transform into the Fourier domain, applying an FFT. Another filtering operation is performed in the Fourier domain. See, e.g., pre-filtering options in U.S. Pat. Nos. 6,988,202, 6,614,914, and 9,182,778, which are hereby incorporated by reference in their entirety.

For more on filters, also see U.S. Pat. No. 7,076,082, which is hereby incorporated by reference in its entirety. This patent describes a multi-axis filter, e.g., an oct-axis filter. Oct axis compares a discrete image sample with eight neighbors to provide a compare value (e.g., +1 for positive difference, −1 or negative difference) and sums the compare values. Different arrangements of neighbors and weights may be applied to shape the filter according to different functions. Another filter variant is a cross shaped filter, in which a sample of interest is compared with an average of horizontal neighbors and vertical neighbors, which are then similarly summed.

Next, synchronization process (404) is executed on a filtered block to recover the rotation, spatial scale, and translation of the encoded signal tiles. This process may employ a log polar method as detailed in U.S. Pat. No. 6,614,914 or least squares approach of U.S. Pat. No. 9,182,778, to recover rotation and scale of a synchronization signal comprised of peaks in the Fourier domain. To recover translation, the phase correlation method of 6,614,914 is used, or phase estimation and phase deviation methods of U.S. Pat. No. 9,182,778 are used.

Alternative methods perform synchronization on an implicit synchronization signal, e.g., as detailed in U.S. Pat. No. 9,747,656.

Next, the decoder steps through the embedding locations in a tile, extracting bit estimates from each location (406). This process applies, for each location, the rotation, scale and translation parameters, to extract a bit estimate from each embedding location (406). In practice, as it visits each embedding location in a tile, it transforms it to a location in the received image based on the affine transform parameters derived in the synchronization, and then samples around each location. It does this process for the embedding location and its neighbors to feed inputs to an extraction filter (e.g., oct-axis or cross shaped). A bit estimate is extracted at each embedding location using filtering operations, e.g., oct axis or cross shaped filter (see above), to compare a sample at embedding locations with neighbors. The output (e.g., 1, −1) of each compare operation is summed to provide an estimate for an embedding location. Each bit estimate at an embedding location corresponds to an element of a modulated carrier signal.

The signal decoder estimates a value of each error correction encoded bit by accumulating the bit estimates from the embedding locations of the carrier signal for that bit (408). For instance, in the encoder embodiment above, error correction encoded bits are modulated over a corresponding carrier signal with 16 elements (e.g., multiplied by or XOR with a binary anti-podal signal). A bit value is demodulated from the estimates extracted from the corresponding embedding locations of these elements. This demodulation operation multiplies the estimate by the carrier signal sign and adds the result. This demodulation provides a soft estimate for each error correction encoded bit.

These soft estimates are input to an error correction decoder to produce the payload signal (410). For a convolutional encoded payload, a Viterbi decoder is used to produce the payload signal, including the checksum or CRC. For other forms of error correction, a compatible decoder is applied to reconstruct the payload. Examples include block codes, BCH, Reed Solomon, Turbo codes.

Next, the payload is validated by computing the check sum and comparing with the decoded checksum bits (412). The check sum matches the one in the encoder, of course. For the example above, the decoder computes a CRC for a portion of the payload and compares it with the CRC portion in the payload.

At this stage, the payload is stored in shared memory of the decoder process. The recognition unit in which the decoder process resides returns it to the controller via its interface. This may be accomplished by various communication schemes, such as IPC, shared memory within a process, DMA, etc.

Technology for so-called “sparse” mark encoding (e.g., encoding with variable density to adapt for visual quality and reliability) is described in, e.g., Digimarc's US Published Patent Application Nos. US 2016-0275639 A1, US 2019-0171856 A1, and US 2019-0332840 A1, and PCT international patent application no. PCT/US19/19410, filed Feb. 25, 2019 (published as WO 2019/165364), each of which is hereby incorporated herein by reference in its entirety. A sparse mark may include a pattern of spatial locations where ink is deposited or not (or where an area is engraved or not). For example, a sparse signal may be comprised of ink dots on a light background, such that the signal forms a pattern of subtly darker spatial locations. The signal is designed to be sparse by the spacing apart of the darker locations on the light background. Conversely, the signal may be designed as an array of lighter “holes” on a relatively darker background. In still other cases, the signal may include a pattern of both darker and lighter signal elements.

### II. Copy Detection Using Line Features and Encoded Signals

This Section II describes copy detection using line features and encoded signals, e.g., such as those signals described above in Section I, and as further described below.

### Further Encoding

Initially, let us drill down into some further encoding details.

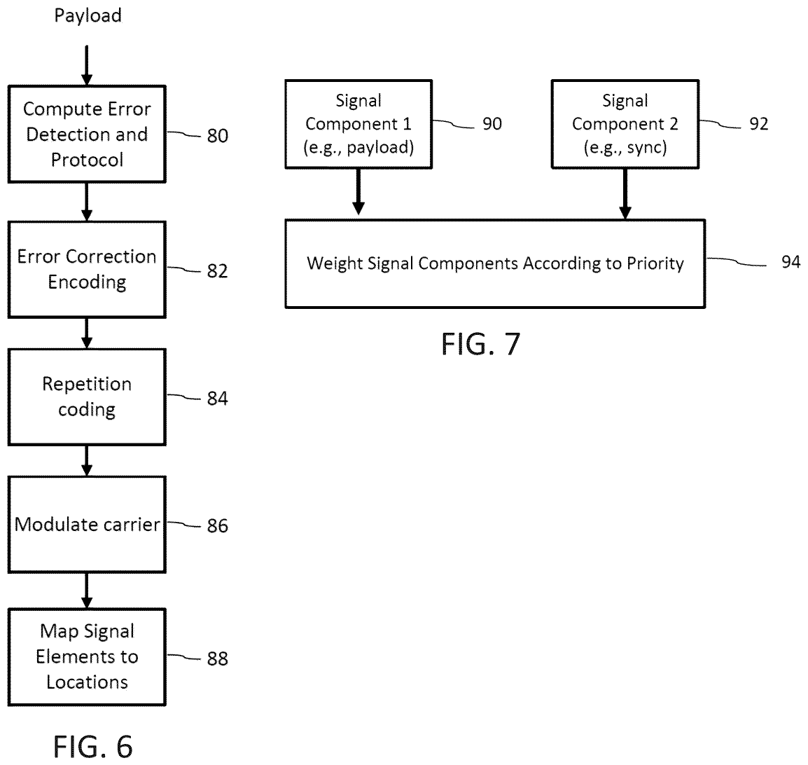

FIG. 6 is a flow diagram illustrating operations of an example signal generator. This signal generator may be used to generate raw data signal tiles. Each of the blocks in the diagram depict processing modules that transform the input payload data into a data signal structure. For a given data signal protocol, each block provides one or more processing stage options selected according to the protocol. In processing module 80, the data payload is processed to compute error detection bits, e.g., such as a Cyclic Redundancy Check, Parity, check sum or like error detection message symbols. Additional fixed and variable messages used in identifying the protocol and facilitating detection, such as synchronization signals may be added at this stage or subsequent stages.

Error correction encoding module 82 transforms the message symbols into an array of encoded message elements (e.g., binary or M-ary elements) using an error correction method. Examples include block codes, BCH, Reed Solomon, convolutional codes, turbo codes, etc.

Repetition encoding module 84 repeats the string of symbols from the prior stage to improve robustness. Repetition encoding may be removed and replaced entirely with error correction coding. For example, rather than applying convolutional encoding (e.g., at 1/3 rate) followed by repetition (repeating three times), these two can be replaced by convolution encoding to produce a coded payload of approximately the same length.

Next, carrier modulation module 86 takes message elements of the previous stage and modulates them onto corresponding carrier signals. For example, a carrier might be an array of pseudorandom signal elements, with equal number of positive and negative elements (e.g., 16, 32, 64 elements), or another waveform. In the case of positive and negative elements, the payload signal is in the form of a binary antipodal signal. It also may be formed into a ternary (of 3 levels, −1, 0, 1) or M-ary signal (of M levels).

Mapping module 88 maps signal elements of each modulated carrier signal to locations. These may be spatial locations with a tile. They may also be spatial frequency locations. In this case, the signal elements are used to modulate frequency domain values (such as magnitude or phase). The resulting frequency domain values are inverse transformed into the spatial domain to create a raw data signal tile in the spatial domain.

Mapping module 88 also maps a synchronization signal to locations. These locations may overlap or not the locations of the payload. The encoded payload and synchronization signal are signal components that are weighted and together, form the raw data signal of a tile. Unless specifically noted otherwise, we use the term “raw data signal” to include both an encoded payload and a synchronization signal, perhaps in a weighted or prioritized fashion.

To accurately recover the payload, a reader extracts estimates of the coded data signal at their locations within a tile. This requires the reader to synchronize the image under analysis to determine the tile locations, and signal element locations within the tiles (we sometimes refer to these signal elements as “waxels”). The locations are arranged in two dimensional blocks forming each tile. The synchronizer determines rotation, scale and translation (origin) of each tile and/or one or more waxels within the tile.

The raw data signal tile comprises an explicit and/or implicit synchronization signal. An explicit synchronization signal is a signal component separate from the encoded payload that is included with the encoded payload, e.g., within the same tile. An implicit synchronization signal is a signal formed with the encoded payload, giving it structure that facilitates geometric synchronization. Examples of explicit and implicit synchronization signals are provided in our U.S. Pat. Nos. 6,614,914, 5,862,260, 6,625,297, 7,072,490, and 9,747,656, which are hereby incorporated by reference.

One example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference.

Applying the method of FIG. 6, the payload is formatted into a binary sequence, which is encoded and mapped to the locations of a tile. For illustration, we describe an implementation of an N by M array of bit cells. The parameters, N and M are integers, and the tile is comprised of an N by M array of bit cells. The size of the tile is configurable and depends on application requirements, such as payload capacity per unit area, robustness, and visibility. Payload capacity increases per unit area with the increase in bit cells per unit area. This additional capacity may be used to improve robustness by redundantly encoding the payload in plural bit cells. Visibility tends to decrease with higher spatial resolution (higher spatial density of bit cells), as the HVS (Human Visual System) is less sensitive to changes at higher spatial frequencies. Examples of bit cell array sizes include 64 by 64, 128 by 128, 256 by 256 and 512 by 512. While each of these is square and has a dimension that is power of 2, the tile need not be so limited. The bit cells correspond to spatial locations within a tile. In particular, the spatial locations correspond to pixel samples at a configurable spatial resolution, such as 75-600 DPI (dots per inch). The payload is repeated in contiguous tiles of artwork. An instance of the payload is encoded in each tile, occupying a block of artwork having a size that depends on the number of bit cells per tile and the spatial resolution. The tile is redundantly encoded in several contiguous tiles, providing added robustness, as the detector accumulates signal estimates for a payload across tiles. Additionally, the entire payload may be extracted from a portion of a tile in configurations where it is redundantly encoded in sub-tile regions.

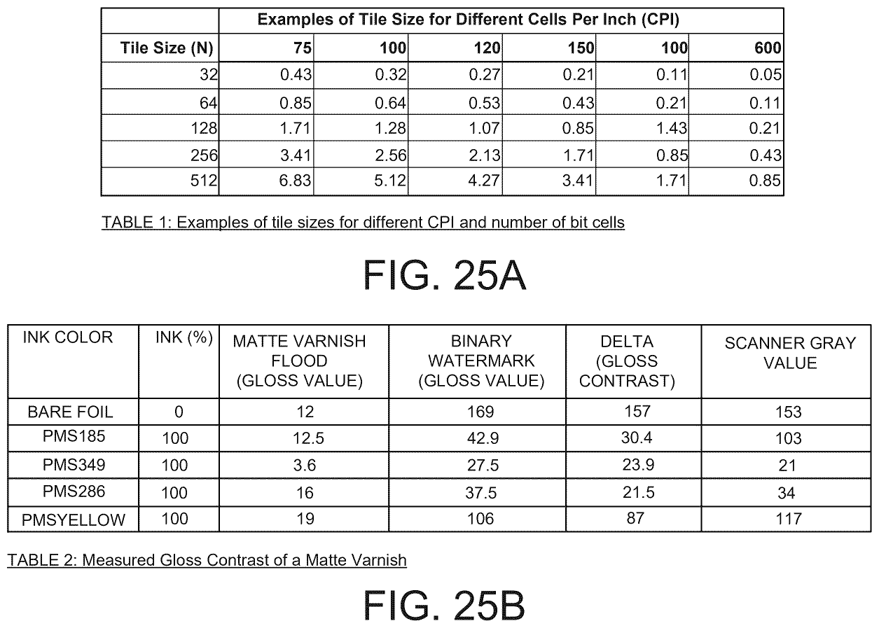

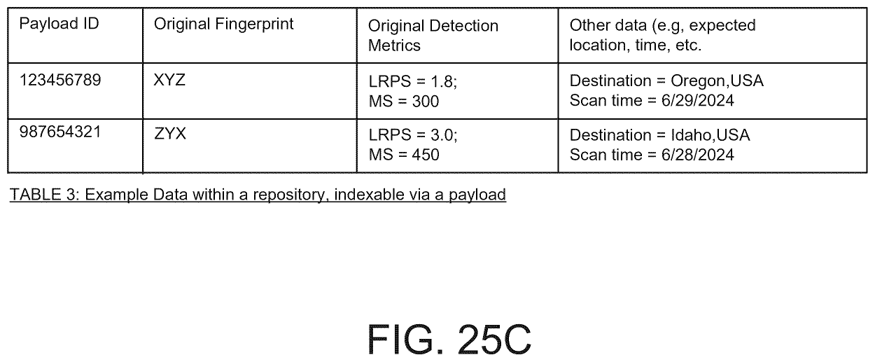

A few examples will help illustrate the parameters of a tile. The spatial resolution of the bit cells in a tile may be expressed in terms of cells per inch (CPI). This notation provides a convenient way to relate the bit cells spatially to pixels in an image, which are typically expressed in terms of dots per inch (DPI). Take, for example, a bit cell resolution of 75 CPI. When a tile is encoded into an image with a pixel resolution of 300 DPI, each bit cell corresponds to a 4 by 4 array of pixels in the 300 DPI image. As another example, each bit cell at 150 CPI corresponds to a region of 2 by 2 pixels within a 300 DPI image and a region of 4 by 4 pixels within a 600 DPI image. Now, considering tile size in terms of N by M bit cells and setting the size of a bit cell, we can express the tile size by multiplying the bit cell dimension by the number of bit cells per horizontal and vertical dimension of the tile. Below is a table of examples of tile sizes in inches for different CPI and number of bit cells, N in one dimension. In this case, the tiles are square arrays of N-by-N bit cells. Table 1 (FIG. 25A) provides example of tile sizes for different CPI and number of bit cells.

These examples illustrate that the tile size varies with bit cells per tile and the spatial resolution of the bit cells. These are not intended to be limiting, as the developer may select the parameters for the tile based on the needs of the application, in terms of data capacity, robustness and visibility.

There are several alternatives for mapping functions to map the encoded payload to bit cell locations in the tile. In one approach, prioritized signal components from the above optimization process are mapped to locations within a tile. In another, they are mapped to bit cell patterns of differentially encoded bit cells as described in U.S. Pat. No. 9,747,656, incorporated above. In the latter, the tile size may be increased to accommodate the differential encoding of each encoded bit in a pattern of differential encoded bit cells, where the bit cells corresponding to embedding locations at a target resolution (e.g., 300 DPI).

For explicit synchronization signal components, the mapping function maps a discrete digital image of the synchronization signal to the host image block. For example, where the synchronization signal comprises a set of Fourier magnitude peaks or sinusoids with pseudorandom phase, the synchronization signal is generated in the spatial domain in a block size coextensive with the tile.

This signal component is weighted according to the priority relative to the payload component as discussed below.

The generation of artwork from the raw data signal results in loss of data signal. This occurs because the transformations remove or distort portions of a dense data signal tile. For instance, as sparsity of graphical elements increases with thresholding, skeletonizing, and editing the skeletal representation, data signal elements are removed or altered, which reduces robustness. This reduces the capacity of the data channel in a given tile region of the artwork. In some cases, there can be contention between allocation of the remaining data channel to components of the data signal, such as the synchronization and payload components. In our U.S. Pat. No. 9,635,378, incorporated herein by reference in its entirety, we discuss ways to allocate a sparse data channel to components of a data signal, including synchronization and payload components. These methods of generating a sparse data signal may be used in the above techniques in which graphical objects are positioned at the location of sparse signal within a tile.

Incorporating the data signal into artwork also impacts the prioritization of signal components in the data channel of the artwork. This occurs because the artwork can interfere differently with the signal components. In addition, the amount of signal capacity dedicated to synchronization and payload to achieve reliable detection varies with the artwork design. Thus, the ratio of the signal components should be adapted for the artwork.

Here we discuss strategies for prioritizing signal components to counteract loss of robustness. FIG. 7 is a diagram illustrating a method of weighting elements of a raw data signal. The signal generator produces signal components. These include components that carry a subset of the payload bits (90) and components that provide synchronization (92). In block 94, the signal generator weights the components according to their priority. This priority is then used in the artwork generation to control which of the data signal elements are retained.

In one approach for adapting artwork to carry signals, the above process for editing the artwork is executed with different weightings for the payload and synchronization components for a candidate artwork design and editing strategy. This yields several variants of the artwork carrying the data signal. Additional permutations of each variant are then generated by distorting the artwork according to image shifts, rotation angles, reducing and enlarging spatial scale, noise addition and blur. Robustness measures based on both correlation with a reference signal for synchronization and correlation with the message signal are computed and stored for each artwork variant. Additionally, the reader is executed on each variant to determine whether it successfully decodes the payload. The component weighting and robustness metric thresholds are then derived by analyzing the distribution of ratio of components that lead to successful payload decoding. The distribution illustrates which ratios and robustness metric values are required to lead to reliable detection. These ratios and robustness metrics are then used for the candidate artwork design and signal encoding method in an automated data encoding program.

Another approach optimizes the data signal in sparse artwork. To be compatible with sparse artwork, the data signal is also sparse and is structured to be consistent with the sparse artwork. Sparse data signals can be binary (0,1), trinary (−1,0,1), or other coarse quantization. Sparse signals are assumed to be low density, e.g., less than 50% ink or less than 50% space. Since the signal has maximum robustness at 50%, any optimal sparse algorithm should increase in robustness as the ink/space density tends toward 50%. Sparse signals maintain robustness by using thresholds to create binary or trinary signals. These binary or trinary signals ensure that the detection filter will return a maximum value at desired signal locations. Between the sparse locations in the artwork, the detection filter will output a Gaussian distribution between maximum negative and positive outputs due to random noise introduced by the image capture (namely, scanner or camera noise). The Gaussian width depends on the amount of blur included in the image capture processing.

During optimization of sparse signals, a small amount of filtered noise can be added to account for the fact that the detection filter will create non-zero values everywhere due to noise of the image capture device. The optimization parameters for sparse signals include synchronization signal to payload signal weighting and thresholds. There is a single threshold for sparse signals. It is a negative threshold for low ink density, <50%, and a positive threshold for high ink density, >50% (e.g., unprinted dots surrounded by a dark background). There is a dual positive and negative threshold for trinary signals. The robustness objective is the same for dense and sparse signals. Namely, it is a detection robustness over the targeted workflow environment, which is modeled with distortions to the encoded artwork.

Now consider encoding signals within line art. Line art includes designs having a various line structure, which can be tweaked or modified to carry an encoded signal. For example, line width modulation (LWM), Line Continuity Modulation (LCM), Line Angle Modulation (LAM), Line Frequency Modulation (LFM), Line Thickness Modulation (LTM), e.g., as described in assignee's U.S. Pat. No. 9,718,296, which is hereby incorporated herein by reference in its entirety, can be used to convey encoded signals within line art or line structures.

Generally, from U.S. Pat. No. 9,718,296, one technology posits a virtual grid of points imposed on a line art image, with the points spaced at regular intervals in vertical and horizontal directions. (The horizontal and vertical intervals need not be equal.) The virtual points may be imposed over some or all of the line art image at vertical and horizontal spacings of 250 μm. In regions of the line art image having line art, the component lines of the art snake in and amongst these virtual grid points.

Each grid point can be the center of a rounded or square region. The luminance (or chrominance) of the region is a function of the proximity of any line(s) within the boundary of the region to the region's center point, and the thickness of the line(s). To change the luminance of the region, the contour of the line(s) is changed slightly within the region. In particular, the line is made slightly thicker to decrease luminance; or thinner to increase luminance. (Unless otherwise noted, darker or color lines on lighter backgrounds are presumed.) The ability to effect these slight changes is then employed, in accordance with known pixelation-based watermarking techniques, to encode binary data in the line art. In an alternative embodiment, the line widths are not changed. Instead, the positions of the lines are shifted slightly towards or away from certain virtual grid points to affect an increase or decrease in the corresponding area's luminosity, with the same effect. Other embodiments are also detailed.

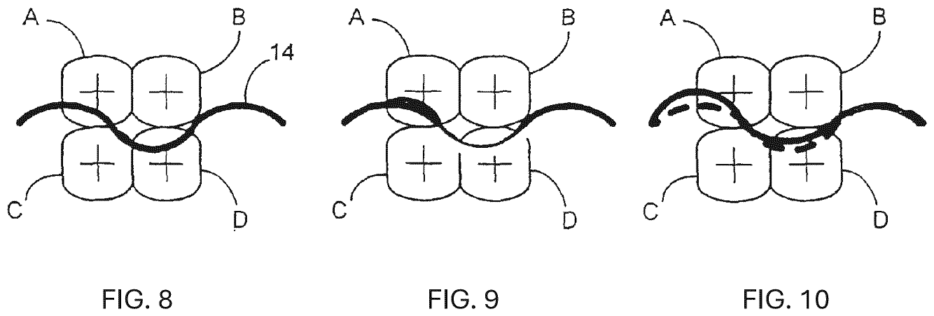

FIG. 8 (corresponding to FIG. 4 in the U.S. Pat. No. 9,718,296 patent) shows a line 14 passing through a virtual grid of points. The width of the line, of course, depends on the particular image of which it is a part. The illustrated line is about 25 μm in width: greater or lesser widths can naturally be used.

As shown in FIG. 9 (corresponding to FIG. 5 in the U.S. Pat. No. 9,718.296 patent), width of the line is controllably varied so as to change luminosity of the regions through which it passes. To increase luminosity (or reflectance), the line is made narrower (e.g., less ink in the region). To decrease the luminosity, the line is made wider (e.g., more ink). Whether the luminance in a given region should be increased or decreased depends on the particular watermarking algorithm used. Any algorithm can be used, by changing the luminosity of regions 12 as the algorithm would otherwise change the luminance or colors of pixels in a pixelated image. In an exemplary algorithm, the binary data is represented as a sequence of −1s and 1s, instead of 0s and 1s. (The binary data can comprise a single datum, but more typically comprises several. In an illustrative embodiment, the data comprises 100 bits.) The changes to line widths in regions A and D of FIG. 9 are exaggerated for purposes of illustration. While the illustrated variance is possible, most implementations will modulate the line width 3-50% (increase or decrease).

Each element of the binary data sequence can be then multiplied by a corresponding element of a pseudo-random number sequence, comprised of −1s and 1s, to yield an intermediate data signal. Each element of this intermediate data signal is mapped to a corresponding sub-part of the image, such as a region 12. The image in (and optionally around) this region is analyzed to determine its relative capability to conceal embedded data, and a corresponding scale factor is produced. Exemplary scale factors may range from, e.g., 0 to 3. The scale factor for the region is then multiplied by the element of the intermediate data signal mapped to the region in order to yield a “tweak” value for the region. In the illustrated case, the resulting tweaks can range from −3 to 3. The luminosity of the region is then adjusted in accordance with the tweak value. A tweak value of −3 may correspond, e.g., to a −5% change in luminosity: −2 may correspond to −2% change: −1 may correspond to −1% change: 0 may correspond to no change: 1 may correspond to +1% change; 2 may correspond to +2% change, and 3 may correspond to +5% change.

In FIG. 10 (corresponding to FIG. 6 in the U.S. Pat. No. 9,718,296 patent), the watermarking algorithm determined that the luminance of region A should be reduced by a certain percentage, while the luminance of regions C and D should be increased by certain percentages. In region A, the luminance is reduced by increasing the line width. In region D, the luminance is increased by reducing the line width; similarly in region C (but to a lesser extent). No line passes through region B, so there is no opportunity to change the region's luminance. This is not fatal to the method, however, since the watermarking algorithm redundantly encodes each bit of data in sub-parts spaced throughout the line art image. In FIG. 10 the original position of the line is shown in dashed form, and the changed position of the line is shown in solid form. To decrease a region's luminosity, the line is moved slightly closer to the center of the grid point; to increase a region's luminosity, the line is moved slightly away. Thus, in region A, the line is moved towards the center grid point, while in region D it is moved away.

Another encoding technique, as disclosed in assignee's US Published Patent Application No. US 2004-0263911 A1, which is hereby incorporated herein by reference in its entirety, is referred to as “Line Continuity Modulation or “LCM”. This method embeds watermarks by modulating a continuity of line structures. For example, an auxiliary signal is embedded in a line image by selectively breaking the lines where the embedding location value is zero. Another example encodes watermark information by introducing subtle modifications in a design structure to create light and dark areas corresponding to watermark components or data carriers.

LWM and LCM can be thought of as part of a broad class of techniques that encode a signal by modulating characteristics of a design structure to create subtle light and dark areas corresponding to binary 1s and 0s (or intermediate values that can be processed to yield binary 1s and 0s).

Additional line modulation techniques and combinations are described below.

Line Angle Modulation—Line structures often have a dominant angle or orientation. One way of embedding watermark information is to vary (modulate) the line angles within the design to create 0s and 1s. For example, the vertical lines represent 0s and the horizontal lines represent is (or a distance between horizontal lines represents data.) In another implementation a transition between a first angle (e.g., a horizontal) and a second angle (e.g., a vertical) conveys data. In still another implementation, lines or graphics can be oriented with respect to a known angle of structure provided on a document. For example, a visible fiducial or graphic provides a base orientation through its own orientation. Then, orientation of line structures around the document are evaluated to determine their orientation with respect to the visible fiducially or graphic. These techniques can be used to embed robust watermarks. This method embeds a watermark using Line Angle Modulation such that the watermark is preferably not visible in the original, e.g., the line structures appear as a uniform field in the original document. After copying, due to limitations of the copying process, certain angles alias and cause the watermark to appear in the copy. An example of such a watermark is shown in FIG. 8.

Line Frequency Modulation—A digital watermark can also be embedded by modulating the frequency of the line structures. This technique provides additional flexibility in tying the watermark feature closely with the design structures. For example, for line structures having constant width (thickness), the frequency of the structures can be increased or decreased to embed 1s and 0s. The frequency is used to convey the data.

An alternative method of using frequency modulation “warps” or contorts an image to carry the watermark information. Consider that a design is laid out on a stretchable surface. Now imagine compressing the design structures in some areas and stretching the design structures in other areas to create dense and sparse regions respectively. Compressed regions will appear darker (more ink in given area) while stretched regions appear lighter (less ink in given area). This process can be used to encode watermark information.

Line Thickness Modulation—This technique is a modification of the LWM technique. Here, the width of each line structure, or of a set of line structures, is maintained constant throughout its length. However, the width of adjacent line structures is varied to embed 0s and 1s. In contrast with LWM, this technique may apply to sparser design structures.

Combination of techniques—Multiple techniques can be combined in design elements throughout a design depending upon the characteristics of the design structures. These techniques can be used to embed multiple watermarks at different resolutions as well. For example, LCM can be used for higher resolution watermarks whereas Line Frequency Modulation and Line Thickness Modulation (LTM) can be used for encoding lower resolution watermarks. Or, both LCM and LTM can be used together in the same design.

### Copy Detection Using Line Features and Encoded Signals

Now consider an embodiment where an encoded signal is carried line art. In a first example, line art is included in a design and the line art is modified to include the encoded signal. For example, line width modulation (LWM) or Line Continuity Modulation (LCM) is used to tweak or modulate lines within the line art. Other types of modulated line art can alternatively be used. The modulated line art includes the encoded signal therein and can then be printed on a printed object, e.g., a value document. For the purposes of this disclosure, value documents are broadly defined and may include, e.g., lottery tickets, credit cards, bank cards, debit cards, phone cards, passports, driver's licenses, network access cards, employee badges, security cards, visas, immigration documentation, national ID cards, voter registration cards, citizenship cards, social security cards, security badges, certificates, identification cards or documents, police ID cards, border crossing cards, legal instruments or documentation, security clearance badges and cards, firearm permits and concealed carry permits, financial documents, certified checks, tax stamps, gift certificates, gift cards, rechargeable (e.g., load money onto) credit and gift cards, labels or product packaging, membership cards and/or badges.

An encoded signal carried within modified line art may include a synchronization component that allows resolution determination of an orientation, scale, and/or start location (e.g., origin) or encoded signal components at time of embedding, e.g., as discussed above in Section I. We'll sometimes refer to these as “base orientation,” “base scale” and “base origin”.

The line art and modified line art include a spacing or closeness between its lines. The term “frequency” of lines in line art refers to how closely the lines are spaced or how densely they are laid out within artwork. In some cases, the frequency can be measured in or referred to as Lines Per Inch (LPI). This can have various effects on the overall appearance and style of the artwork. For example, a higher frequency of lines, meaning more lines packed into a smaller area, can suggest more detail or texture. Closer spaced lines can make areas appear darker or more shadowed, while wider-spaced lines can suggest lighter areas.

The Discrete Fourier Transform (DFT) is a tool used in image signal processing for analysis and manipulation of image signals in the frequency domain. It can be used to analyze frequency content of image signals including line art. The DFT decomposes or breaks down a signal into constituent sinusoidal components. This decomposition facilitates analysis of a signal's frequency content. Of course, in image signal processing, the 2D Fast Fourier Transform (FFT) is a computational technique that efficiently calculates the 2D Discrete Fourier Transform (DFT). Both can be used to analyze frequency content of two-dimensional data, such as images or spatial grids, but the FFT is an optimization that can reduce computational complexity. “Energy” in this context may refer to a measure of the image signal's power or intensity across its components, expressed in terms of magnitude of its frequency components. The concept of energy in the frequency domain helps explain how an image signal's power is contained within specific frequencies.

A DFT of line art with straight parallel lines produces distinct peaks in the frequency domain. These peaks represent the spatial frequencies of the lines. The location of the peak(s) in the frequency spectrum indicates the orientation of the lines. For example, vertical lines will produce a horizontal frequency component, and horizontal lines will produce a vertical frequency component. The distance of the peak from the center of the frequency spectrum (DC or zero frequency) corresponds to the spacing of the lines. Closer lines (higher spatial frequency) result in peaks that are farther from the center. The primary frequency component will show up as a delta function (e.g., a spike) at a frequency corresponding to an inverse of the distance between the lines. If the lines are very close together, the frequency component will be further from the center, indicating a higher spatial frequency.

Curved lines, unlike straight lines, do not produce a simple, repetitive pattern across the spatial domain. The curvature introduces variations in both magnitude and direction, affecting the frequency content captured by the DFT. The frequency components shown by the DFT will not be as distinct or sharp as those for straight lines. Instead, they may appear as a spread of energy across various frequencies. Complexity of curves within line art affects frequency spread. Gently curving lines, like a part of a circle or an ellipse, might still show some distinct peaks in the frequency domain, though less sharp than those for straight lines. More complex curves, such as spirals or irregular wavy patterns, result in a much more dispersed frequency spectrum, with energy spread over a wide range of frequencies and directions.

In some cases, value documents are printed using so-called spot colors. A spot color is a pre-mixed ink used in printing that is applied to specific areas of a print job, rather than created through the combination of the four standard process colors (cyan (C), magenta (M) and/or yellow (Y) components and black (K), collectively, CMYK). Pantone® defines scores of such spot colors; others are likewise available. Line art can be printed using a spot color. To reproduce line art that includes a spot color but using a CMYK (or other) printer, which does not have the spot color ink, a combination of CMYK components can be utilized to approximate the spot color. In a first example, let's say the spot color is a green spot color. In a CMYK color model, green is not a primary color, so it must be approximated by mixing cyan and yellow inks. The specific shade of the green spot color (e.g., lime green, forest green, etc.) determines the proportion of cyan and yellow used.

Halftoning can be used to create an illusion of varying colors and shades by varying a size and spacing of printed dots of each primary color. For reproducing green, the printer adjusts dot sizes and spacing of cyan and yellow dots. The cyan and yellow dots are typically printed at different angles. Commonly, cyan might be printed at a 0-degree angle (or 15-degrees) and yellow at a 90-degree angle, though these angles can vary depending on the specific printing setup. In some cases, overprinting might be used where yellow ink is printed over cyan ink (or vice versa) to create a deeper or more specific shade of green. This technique can help in achieving a desired hue and saturation. Thus, a CMYK printer can approximate the appearance of green spot color in line art, even though it does not directly use green spot color ink. The printer applies the cyan and yellow inks through halftoning to mimic the desired green spot color.

With this as context, let's now explore a first embodiment that utilizes modulated line art (to carry an encoded signal), frequency response analysis of lines within the modulated line art, and halftone detection to determine whether a value document is an original or suspected copy. In a first implementation of this embodiment, an encoded signal and a frequency domain metric associated with a frequency of the line art is carried out to determine whether a value document is an original or is a copy. In a second implementation of this embodiment, the encoded signal, the frequency domain metric associated with a frequency of the line art, and a halftoning check is carried out to determine whether a value document is an original or is a copy.

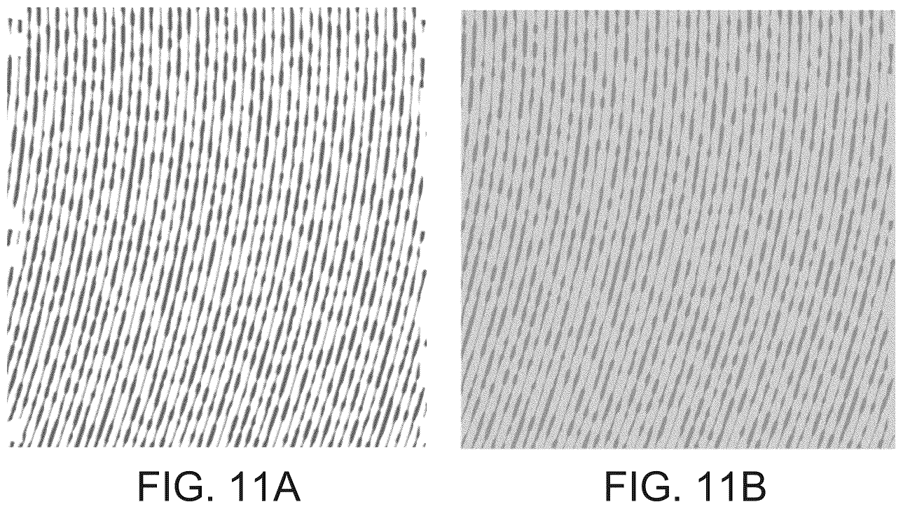

A value document is printed to include a line art pattern that has been modulated to include an encoded signal therein. The modulated line art pattern is printed with a spot color, e.g., red, blue or green, (as shown FIG. 11A), or other spot color. FIG. 11A shows an excerpt of such modulated line art. The encoded signal preferably includes a synchronization component and a message component (e.g., a plural-bit payload). The modulated line art includes a plurality of lines spaced apart at a frequency or LPI. The modulated line art pattern is printed such that a base orientation, base scale and base origin can be determined relative to the synchronization component. The message component may include or link to information, e.g., document identification number, printing batch number, value document type and/or amount, expected line art spacing frequency, encoded signal version, issuing authority, etc. FIG. 11B illustrates a captured greyscale image depicting the FIG. 11A excerpt (e.g., corresponding to the Y channel (luminance or brightness) in a Yuv color model provided by an image sensor). This image was captured with an iPhone 12 using 4K resolution capabilities. Of course, other cameras (e.g., other iPhones and Android devices) will produce suitable greyscale imagery.

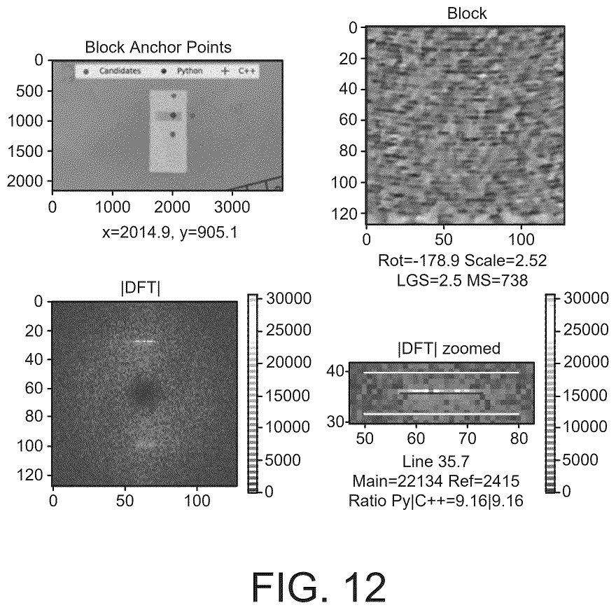

In the first implementation, the authenticity of a value document including the modulated line art proceeds by determining whether an encoded signal is recoverable and whether the line art includes expected properties (e.g., frequency response of its lines). The following description refers to a process shown in FIG. 12.

A camera captures an image of modulated line art printed on a value document. For example, FIG. 11B depicts an image captured that depicts modulated line art. An encoded signal detector (e.g., a digital watermark detector) analyzes the captured imagery to detect an encoded signal carried within the modulated line art. If the encoded signal carries a message component, it can be decoded and used in an authenticity process. In one example, if an encoded signal is detected, a signal anchor point within the encoded signal is located. If the encoded signal includes a digital watermark signal including a synchronization component and a message component, the anchor point may correspond to a spatial location of the digital watermark signal having relative strongest detectability measures (e.g., relative to other signal locations). See assignee's U.S. Pat. No. 11,250,535, which is hereby incorporated herein by reference in its entirety, for a discussion of detectability measures including, e.g., Linear Reference Pattern Strength (LRPS, also called “LGS”) and Message Strength (MS). In one example, the anchor point is determined using the Fidelity Point selection methodology described in the '535 patent. A selected Fidelity Point can be used as an anchor point. In another example, detectability measures are used to identify an anchor point as one having the highest detectability measures relative to neighboring points. For example, in some encoding schemes, an encoded signal is repeated spatially across line art in a tiled pattern. Each tile within the tiled pattern includes a synchronization component and a message component. The search for highest detectability measures may evaluate each of the tiles relative to one another, or relative to various tile neighborhoods, e.g., 4×4, 8×8, 16×16, 32×32 or 64×64 tile neighborhoods, or relative to the entire captured image. The synchronization component can be used to determine a base orientation, a base scale and a base translation (or origin) for the encoded signal.

With reference to FIG. 12, once an anchor point is determined, an image pixel block is exacted around the anchor point. For example, a 64×64, 128×128 or 256×256 image pixel block centered around anchor point is extracted. The image pixel block can be inverted with respect to the base orientation (e.g., rotated 179.9 degrees to achieve the base orientation). The upper right image in FIG. 12 (Block) shows example rotation, example scale and example detectability measures LGS and MS as determined by a detector analyzing the encoded signal.

The line art pattern within the image pixel block can be analyzed within a frequency transform domain to determine if the line frequency corresponds as expected for this value document. For example, a 2D DFT or 2D FFT can transform the image pixel block into a frequency transform domain. In a related implementation, the image pixel block can be filtered to remove image content prior to the transform. For more on image filters, see, e.g., U.S. Pat. No. 7,076,082, which is hereby incorporated by reference in its entirety. This '082 patent describes a multi-axis filter, e.g., an oct-axis filter. Oct-axis compares a discrete image sample with eight neighbors to provide a compare value (e.g., +1 for positive difference, −1 Zor negative difference) and sums the compare values. Different arrangements of neighbors and weights may be applied to shape the filter according to different functions. Another image filter variant is a cross shaped filter, in which a sample of interest is compared with an average of horizontal neighbors and vertical neighbors, which are then similarly summed. Still other image content reduction filters include a medium filter, a Gaussian filter and a Wiener filter.

The lower left image in FIG. 12 shows the frequency magnitude of the filtered image pixel block. Recalling from FIGS. 11A and 11B that the lines are curved within the modulated line art pattern, so more frequencies (or a spread of frequencies) are expected. The lower right image in FIG. 12 shows a zoomed in version of the DFT (lower left). The green line shows frequency energy locations of the lines within the line art pattern in the image pixel block. This frequency energy location can be determined by using the detected encoded signal's scale (here 2.52). Indeed, a location of the detected lines in the frequency domain may be related to image captured distance as estimated from encoded signal scale, since line art depicted in captured image can be rotated or scaled. A frequency domain comparison between an expected frequency location (as conveyed, indexed by or pointed to by the message component or as stored in memory in a detector itself) and detected frequency location can be used as an authenticity clue. For example, a message component can be used to carry or link to an expected line art pattern including, e.g., line pattern orientation (e.g., relative to a synchronization component), line frequency, line shape (e.g., straight or curved). Detected frequency energy locations can be compared against expected frequency energy locations to see if they correspond. For example, if the expected frequency location(s) and the detected frequency location(s) and/or expected energies of such, coincide with the value document is considered authentic. That is, a successful encoded signal detection plus a positive authenticity clue indicates that the value document is an original or otherwise authentic. In one example, a DFT or FFT magnitude ratio between detected location and expected location are compared. The red lines in the lower right image in FIG. 12 correspond to the reference magnitudes. As shown, the magnitude ratio between the reference red (main) and green (ref) is 9.16, which is above a threshold (e.g., greater than 3) to indicate authenticity. In another example, as long as the frequency energy location(s) of the detected lines and the expected lines overlap, the authentication clue is viewed as positive. In still another example, as long as the frequency energy location(s) of the detected lines and the expected lines are found within a predetermined threshold of one another, the authentication clue is viewed as positive.

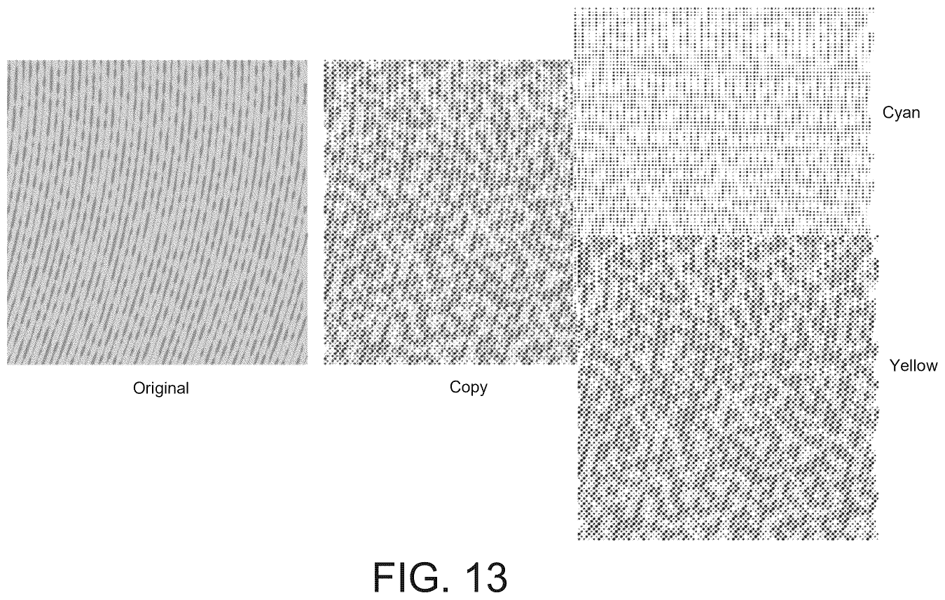

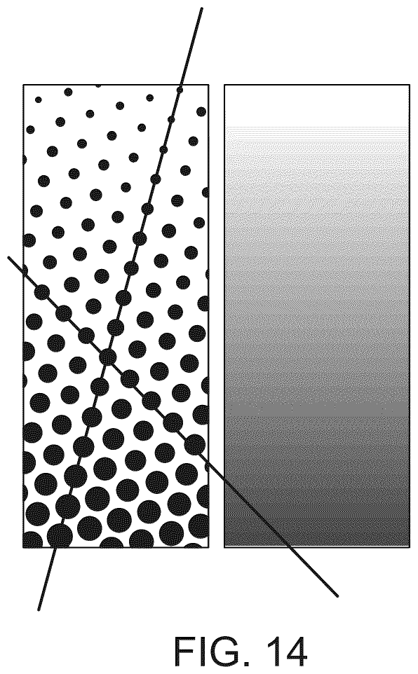

Now consider a second implementation, where an authentication requires a successful encoded signal decode and a positive authentication clue based on a frequency analysis of the line art pattern (as discussed above under the first implementation) and requires a failed halftone detection. It's helpful to consider a copy in this second implementation. With reference to FIG. 13, the FIG. 11B captured greyscale imagery depicting a modulated line art pattern is shown in the top left portion (Original). Recall from above that the modulated line art pattern depicted therein was originally printed using a spot color ink, e.g., green or other spot color. A CMYK printer producing a copy of such relies on a combination of halftone dots to replicate the line pattern. For example, if the original spot color was green, then the CMYK printer will typically use Cyan dots and Yellow dots arranged in a halftone pattern to approximate the green spot color. See FIG. 13, middle image (Copy). The Cyan plane (top) and the Yellow plane (bottom) of dots are shown on the right side of FIG. 13. One example of a general halftone arrangement is shown in FIG. 14. There, a 2D halftone arrangement of dots are shown approximately 90-degrees with respect to horizontal rows and vertical columns.

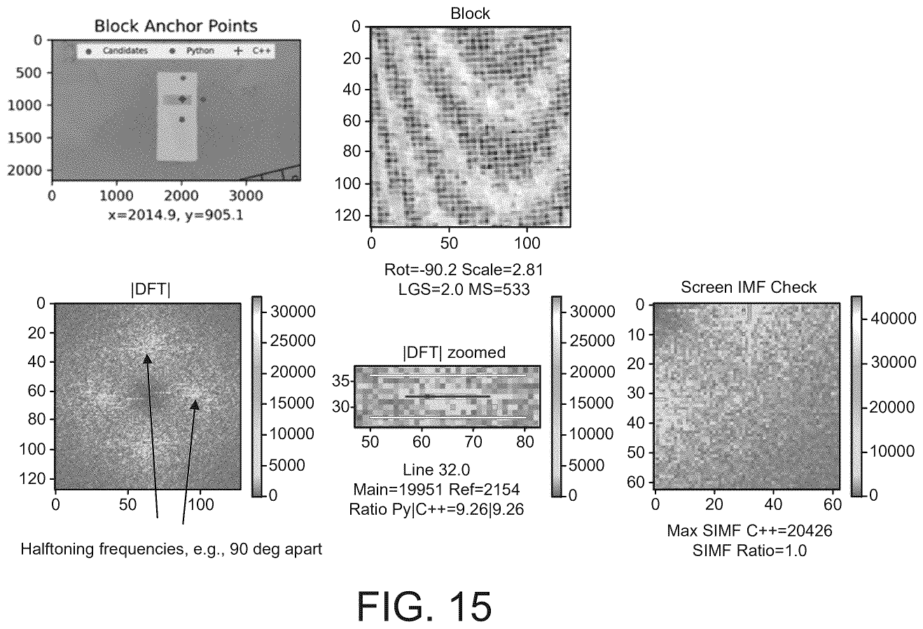

Now, with reference to FIG. 15, an anchor point and image pixel block are determined as in the above first implementation (with reference to FIG. 12), but here, in FIG. 15, from analysis of a copy. A 2D DFT (or 2D FFT) is performed on the filtered image pixel block. The encoded signal is detectable, and the lines appear to be spaced at an expected frequency line (e.g., as conveyed or obtained from a message carried by the encoded signal or as stored in memory in the detector itself). However, halftoning is detectable from a presence of frequencies with a 90-degree rotation symmetry. The presence of halftoning as revealed in the frequency domain indicates that the copy is a copy. Here, halftoning, like rosette patterns, produces a strong periodic pattern in X and Y directions. Such symmetry is identifiable, e.g., via frequency domain analysis. A copy is determined since the halftoning is present, even though the line frequency matched an authentic document as expected. If in the second implementation, where the frequency analysis includes looking for evidence of halftoning, the value document is labeled as a copy if the encoded signal is detected, and the line art frequency check fails to validate or if halftoning evidence is present.

A value document authenticity module can be incorporated into an app or other module and executed by a camera-equipped smartphone (e.g., iPhone or Android-based phone) or tablet (iPad or other tablet). The app can include or communicate with a signal detector (e.g., a digital watermark detector) and a frequency domain authentication module. Consider the operation of such app or other module.

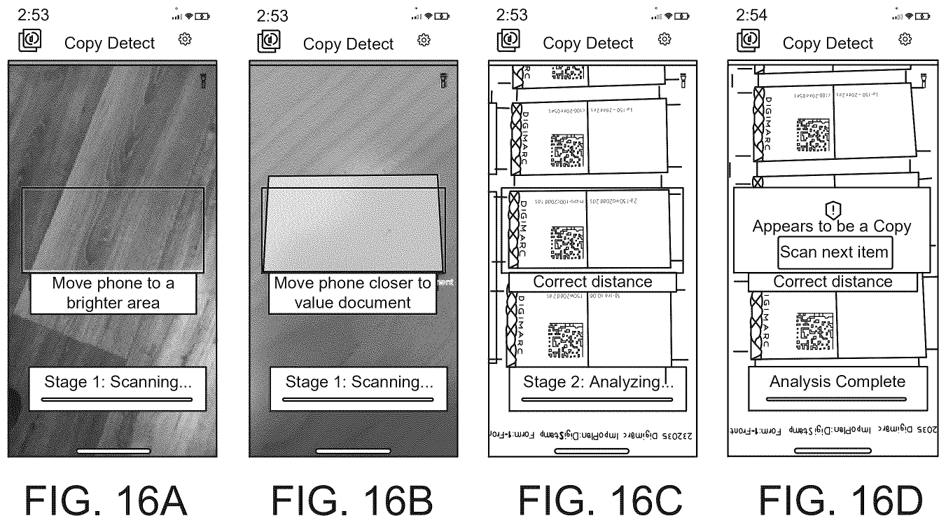

Upon opening, or upon user direction (e.g., pressing a displayed start button/graphic), the app directs a user to position the camera in an area with sufficient brightness (see FIG. 16A) at a correct distance from the value document for better camera focus (see FIG. 16B). E.g., the app can access a camera's autofocus and/or focal distance features to determine when imagery captured by the camera is in focus. (In an alternative arrangement, a digital watermark detector provides feedback to the app, which can be used by the app to prompt a user to position the camera relative to the value document by analyzing synchronization component scale. For example, synchronization scale is determined, and the app prompts the user to position the camera/smartphone closer or farther away from the value document. Such a scale can be predetermined, e.g., position the camera to a point where the scale value is 2-4× the originally embedded scale. The app may start collecting image frames to analyze as the user enters and passes through a scale window, e.g., 2-4× the originally embedded scale.) The signal detector is activated to search for digital watermarks encoded within captured imagery when the camera is at a focused distance (see FIG. 16C) or within a scale window, which keeps device load low and conserves battery power. A “session” starts with a first detected message component carried by an encoded digital watermark. The app checks a payload carried by the message component and confirms that it corresponds to the value document being authenticated. (Optionally, a user can select through a graphical user interface a particular value document to authenticate. Otherwise, the app can be set to a default type of value document. Selecting a particular value document allows the app to access an expected watermark payload, line art frequency, orientation, etc. for the checks discussed above in the first implementation and the second implementation.) The app carries out a line art frequency analysis within each frame of where an encoded signal is detected. The value document is determined as an original or otherwise authentic if the line frequency check is successful after watermark detection and/or in combination with other checks as described herein. The app labels the value document as a copy if the line frequency check is not successful within time limit (see FIG. 16D). Otherwise, app label the value document as not recognized if no encoded signal is within time limit of user being at correct distance.

The app (or a software and/or hardware module cooperating with the app) can be configured to evaluate a plurality of image frames to determine authenticity of a value document. For example, a smartphone captures a video stream depicting a value document. The app evaluates image frames from the captured video stream to perform a variety of checks as described above, e.g., digital watermark detection, line frequency evaluation, and/or halftone detection. The app (or module) aggregates results from across the plurality of image frames to determine whether the value document is an original or copy. For example, the app may tolerate one or more “copy” determination for a given frame if the majority (e.g., greater than 50% or super majority, e.g., 66+%) of the image frames indicate that the value document is an original. Continuing this example, the app (or logic module cooperating with the app) analyzes between, e.g., 3-250 captured image frames. The app (or logic module) issues an original determination when the number of individual “original” determinations outnumber the individual “copy” determinations by a majority or by K amount for the analyzed plurality of image frames, when K is a positive number equal to or between 2 and 10.

In a second embodiment, the first implementation or the second implementation from the first embodiment, is combined with one or more additional copy detection checks. For example, checks to validate one or more of the security features for printed objects from assignee's U.S. Provisional Patent Application No. 63/666,161, filed Jun. 29, 2024, e.g., Section II, Implementations I-V. The 63/666,161 application is hereby incorporated herein by reference in its entirety. Additionally, an authentication app, e.g., like the one discussed above with reference to FIGS. 16A-16D, can be configured to perform a color check of a security feature provided on a value document.

In a first implementation of this second embodiment, a security feature includes some or all of the modulated line art discussed above with respect to FIG. 11B. The modulated line art is printed with a spot color, e.g., red, blue or green or other spot color. To access Yuv color data corresponding to imagery captured by a smartphone's image sensor, the app can communicate with the smartphone's operating system (e.g., iOS or Android) and API's. An example iOS framework for such access is AVFoundation, which provides control over camera settings, including format of the data captured from the camera.

An encoded message is decoded from the modulated line art. The message may include or point to expected color information. In one example, the payload itself includes the line color information, e.g., red, blue or green. In another example, the payload includes an index, encoded signal and/or payload version identifier, e.g., version V21. The app includes (or remotely accesses) a table, array or other data structure which indicates an expected color of the line art for the index, encoded signal and/or payload version identifier. In this example, the payload indicates the lines are expected to be, e.g., deep forest green, with corresponding color values or an index into a color value table or other data structure. Image color data from the image sensor is compared to (e.g., within a predetermined color error) the expected color values to see if they coincide. If they do, the color check is validated; and if not, the color check fails and the value document is considered a copy or otherwise suspect.

Color error in a Yuv color space can be determined, e.g., a Euclidean distance, which is a metric that can be used to quantify color differences. The Euclidean distance formula can be applied to the YUV color model to measure the distance between two Yuv colors: (Y1, U1, V1) and (Y2, U2, V2). The distance is then calculated as:

For more accurate perceptual measurements, the color data can be converted to a color space like CIELAB and then a Delta E metric can be calculated. Delta E (ΔE) can be used to quantify color differences. It's a value number that represents a distance between two colors in a color space, indicating how different the colors are perceived by the human eye. Example Delta E formulas include the CIE 1976 (ΔE*ab), CIE 1994 (ΔE94) and the CIE 2000 (ΔE00). A Delta E value of 1.0 is typically considered the smallest color difference the human eye can see. In the printing world, a ΔE of less than 5 is usually acceptable, where slight differences are not critical to visibility of the printed material. We preferably target a Delta E of less than or equal to 5 (e.g., 5≥ΔE≥0) for our color check. In some cases, a Delta E of less than or equal to 10 (e.g., 10≥ΔE≥0) is acceptable for a color check.

An alternative color check process analyzes characteristics of a group of pixels. For example, the group of pixels can be centered around or otherwise selected relative to an anchor point, as described above. In one implementation, we select a 64 pixel×64 pixel (or, e.g., 128 pixel×128 pixel) block and evaluate color values from that pixel block. One type of evaluation involves a pixel color analysis, e.g., Red vs. Green, as visualized in a scatterplot of pixel color values. (Or a plot of a ratio of red vs. green pixel values.) A line fitting algorithm (e.g., least squares) can be used to determine a slope best representing the scatterplot. The determined slope can be compared to an expected slope of an expected spot color used in the value document being authenticated. (This slope information can be preprogramed into a detector or authentication app. carried by a digital watermark payload, or looked up via the digital watermark payload, or table/array look up based on a user selected value document (e.g., through a GUI provided by the authentication app). If the determined slope varies from the expected slope by an unacceptable amount (e.g., more than 10-25%), the color check fails. This preferably results in an automatic failure of the authentication determination.

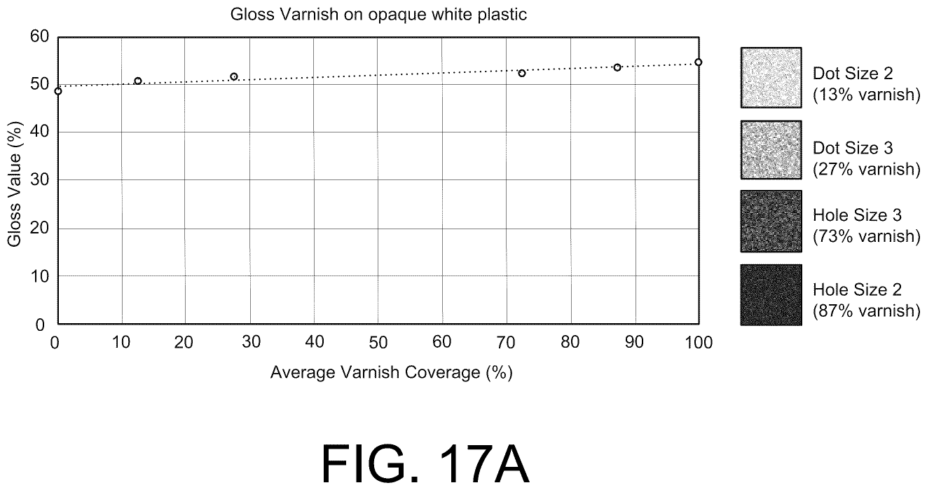

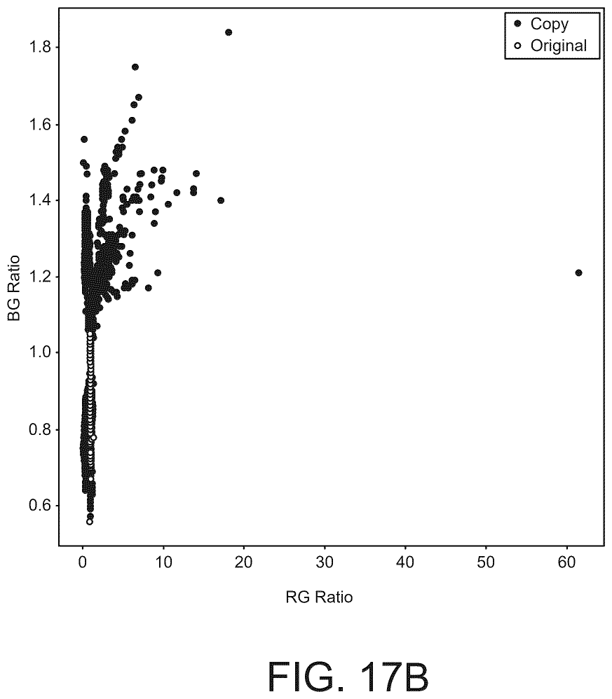

Still another alternative color check process analyzes multi-color ratio characteristics of a group of pixels. Here again, the group of pixels can be centered around or otherwise selected relative to an anchor point. In one implementation, we select a 64 pixel×64 pixel (or, e.g., 128 pixel×128 pixel) block and evaluate color values from that pixel block. For example, a Red-Green (RG) ratio of pixel values is plotted vs. a Blue-Green (BG) ratio of pixel values: we'll call this a determined result. This determined result can be compared against predetermined values of authentic and copy documents. For example, 1000+ value documents are represented in FIG. 17. The green dots represent original value documents, and the red dots represent copies, with originals printed with a green spot color (e.g., as used in FIG. 11B) and the copies printed with yellow and blue process colors. From the plot in FIG. 17, it can be seen that a determined result of a BG ratio over 1.05 should be classified as a copy and an RG ratio over 2 should be considered a copy.

An authentication process may employ a white balance operation to ensure that captured colors from a value document are being interpreted as expected. A first approach relies on identifying a predetermined white area on the value document. This can be located by reference to an anchor point or to a fiducial or other landmark on the value document. When using an anchor point, once a digital watermark detector locates the anchor point, a known white space (e.g., corresponding to white substrate or white ink or varnish) relative to the anchor point is located within a captured image frame. The corresponding color values for the know white space can be used as a white baseline value or to set the white balance. With this known white space as a reference, the app or camera can be calibrated to recognize other colors. This allows for accurate color interpretation (e.g., color values representing spot colors depicted in captured image frames) by an authentication process.

In another implementation of this second embodiment, one or more of the copy detection checks described in the first implementation or in the second implementation from the first embodiment, are combined with one or more classifiers. For example, a classifier can be trained to determine whether a value document is an original or a copy. Initially, a labeled training dataset is established. For example, for a binary classifier, a labeled training dataset may include one or more sets of features (e.g., input variables) and labels (e.g., output classes, e.g., 0 and 1 or “original” and “copy”). Each input variable in the training dataset is labeled as belonging to one of two classes.

In a first example, the input variables include frequency response features (e.g., magnitude values) corresponding to frequency domain energy locations of lines within a line art pattern. See the lower right image in FIG. 12. For example, an average of magnitude values along the line in the frequency domain can be used as an input variable. Or a maximum or minimum (or both) magnitude value can be used. In a second example, frequency domain values corresponding to one or more digital watermark components can be used as input variables. Recall from above that one example of a synchronization signal includes a signal comprised of a set of sine waves, with pseudo-random phase, which appear as peaks in the Fourier domain of the suspect signal. See, e.g., U.S. Pat. Nos. 7,986,807, 6,614,914, and 5,862,260, which are each hereby incorporated by reference in its entirety. Magnitude values from one or more (or all or a subset of all) of such peaks can be used as input variables, e.g., magnitude values summed together, or magnitudes averaged, or magnitudes used as elements in a data array. In a related example, image data is filtered (e.g., oct-axis filter as discussed above) prior to an FFT transformation. Then, frequency domain magnitude values from one or more (or all) of such peaks can be used as input variables. In another related example, magnitude values from a filtered image and from a non-filter image are combined (e.g., averaged, concatenated, added, combined as elements in a data array, etc.) as then used as input values. In a third example, input variable from the first and second examples are combined (e.g., averaged, concatenated, added, combined as elements in a data array, etc.). Input variables can be expanded to include data representing, e.g., digital watermark signal characteristics and/or signal detection results, line frequency characteristics (e.g., frequency domain characteristics), halftone detection characteristics (e.g., frequency domain characteristics) and/or results, color characteristics and/or color ratios, as described above. The training adjusts parameters so that future predicted probability is as close as possible to an actual class of original or copy.

The labeled input variables are provided to a (e.g., binary) classification model, such as: Logistic Regression, Support Vector Machines (SVM), Decision Trees, Random Forest, K-Nearest Neighbors (KNN), and/or Neural Networks. Model parameters can be initialized, e.g., randomly (like weights in neural networks) or set to default values depending on the algorithm. A loss function can be defined, e.g., to quantify how well the model's predictions match the actual labels. The model is then trained and optimized. For example, gradient descent can be used, e.g., in logistic regression and neural network models, to minimize the loss function by iteratively adjusting the model's parameters. Of course, backpropagation (e.g., for neural networks) can be used to update weights by propagating errors backward through the network. Software libraries, such as Scikit-learn in Python, provide implementations of logistic regression that include optimization algorithms and options for regularization. Other logic regression software libraries include, e.g., Statsmodels, TensorFlow, PyTorch, and MLPack (written in C++).

As part of a value document authentication process, a classifier check can then be performed using this trained classifier. For example, input variables (e.g., as discussed above in the training section) can be extracted from a frequency domain analysis (e.g., 2D FFT) of a greyscale image block of a test subject value document. The classifier check passes/fails if the trained classifier produces a value that indicates an original or copy. The value document is labeled as a copy regardless of whether any other authentication checks pass (e.g., watermark detection successful, frequency response as expected, no halftoning found, and/or color check passes).

Instead of using a trained classifier to determine an original or copy, a data set as discussed above (e.g., input variables) can be determined for an original document. The input variables can be stored within an authentication app or accessed remotely via a decoded message component so that during an authentication process, new input variables can be determined and compared against the stored input variables. If the variable match (or vary within a threshold, e.g., 0-5%), then the document is considered authentic. Otherwise, the document is considered a copy.

Another implementation utilizes a fully connected (FC) neural network (a deep learning approach), which may include multiple layers of neurons where each neuron in one layer is connected to one or more neurons in the next layer. The first layer that receives input variables (e.g., as discussed above) directly is an input layer. Such FC networks may include hidden layers (e.g., one or more layers of neurons that process inputs from the previous layer; with each neuron in these layers applies a weighted sum of its inputs and a bias term, followed by a non-linear activation function like ReLU (Rectified Linear Unit), sigmoid, or tanh) and one or more output layers (e.g., a layer that produces the network's output: for classification tasks, a FC network often includes a softmax function for multi-class problems or a sigmoid function for binary classification). Training a fully connected neural network typically involves one or more of the following steps: 1. Initialization: Weights and biases are initially set, often randomly or using heuristics like the Glorot or He initialization methods to aid in convergence. 2. Forward Propagation: Data is passed through the network from the input to the output layer. Each neuron computes the weighted sum of its inputs and applies an activation function. 3. Loss Calculation: The difference between the predicted output and the actual target values is computed using a loss function, e.g., such as mean squared error for regression or cross-entropy loss for classification. 4. Backpropagation: A gradient of the loss function is calculated with respect to each weight and bias in the network by applying, e.g., the chain rule (gradient descent). This process is facilitated by a method known as automatic differentiation, commonly implemented in many deep learning libraries. 5. Weight Update: The weights are updated using an optimization algorithm like Stochastic Gradient Descent (SGD), Adam, or RMSprop, which adjusts the weights to minimize the loss. Iteration/Epochs: Steps 2 through 5 can be repeated for a set number of iterations or epochs over the entire training dataset, often in shuffled batches (mini-batch gradient descent). Example deep learning software libraries include, e.g., TensorFlow (Google Library), PyTorch (developed by Facebook), Microsoft Cognitive Toolkit (CNTK), and MXNet (supported by Amazon Web Services).

A trained fully connected neural network can be used to predict an original or copy value document. Training involves using a data set obtained from copies and original value document, where the data set includes, e.g., digital watermark signal characteristics and/or detection results, line frequency characteristics, halftone detection characteristics and/or detection results.

The following description in this Section II describes technology for distinguishing between original printed documents and copies of those documents using image frequency analysis. The technology leverages the fact that a common copying process, which typically involves optical capture of an original document followed by reprinting using a low-resolution printer, tends to attenuate high frequency components in imagery depicting a printed document. By embedding auxiliary signals (or an auxiliary signal with various components) at high frequencies in original digital artwork for a printed document, in addition to embedding more robust digital watermark signals described above in Section I, the present technology provides a reliable mechanism to detect copies.

A digital watermark is embedded in the original digital artwork. For example, a digital watermark described above in Section I, including an explicit synchronization component, is embedded. One example of an explicit synchronization signal is a signal comprised of a set of sine waves, with pseudo-random phase, which appear as peaks in the Fourier domain. See, e.g., U.S. Pat. Nos. 6,614,914, and 5,862,260, describing use of a synchronization signal in conjunction with a robust data signal. Also see U.S. Pat. No. 7,986,807. Each of the sine waves includes a frequency. Additional signals, e.g., additional sine or cosine waves (or a sum of complex exponentials, modulated carrier waves, or data arranged via 2D Fourier transform of images), can be embedded in the original digital artwork. These additional signals include corresponding frequencies that are higher relative to the synchronization signal. For example, 4-24 additional signals are embedded, each with an expected Fourier domain characteristics (e.g., location, magnitude, and/or a relative relationship to synchronization component characteristics). The expected Fourier domain characteristics can be determined, e.g., relative to one or more Fourier domain locations of the synchronization component and/or based on original placement for a particular printed document. A digital watermark detector, or an authentication module, can be programed with (or given access to) such expected Fourier domain characteristics.

To determine whether a printed document is an original or copy, an authentication module uses or communicates with a digital watermark detector to first orient a captured image depicting the printed document using the digital watermark signal, e.g., via the explicit synchronization component. Once the captured image is properly oriented (e.g., scaled and rotated), the detector or authentication module examines the expected high-frequency locations where the auxiliary signals were embedded in the original digital artwork. By comparing measurements at these locations (e.g., amplitude values) with expected values or as a ratio to the synchronization component's signal frequencies, the authentication module can determine whether the document is an original or a copy.

In some embodiments, an estimated linear transform is utilized to predict expected values of the auxiliary signal at the high frequency locations. In other implementations, a classifier is trained to distinguish between originals and copies based on measurements of the high frequency values. The copy detection technology described in this section exploits fundamental limitations in the document copying process. When a printed document is optically captured (e.g., scanned or photographed) and then reprinted using a low-resolution printer, high frequency components in the image are typically attenuated. This attenuation occurs due to limitations in both the optical capture devices and printing systems used in the copying process.

These auxiliary signals (or a single auxiliary signal have plural components) may be embedded in various ways, including, e.g.: modulating line art features at high frequencies, adding high-frequency texture patterns to image areas, embedding signals in halftone screens, and modifying edge characteristics of text or graphical elements. The auxiliary signals may be embedded in a pattern known to the detector or may be related to the digital watermark signal in a predetermined way. For example, the auxiliary signals might be embedded at frequency locations that are harmonics of the digital watermark synchronization signal frequencies. The auxiliary signals may be arranged to form a pattern in a Fourier domain, e.g., a circle, oval or other pattern shape. The number of frequency domain points for measurement can be varied, e.g., equal to or between 4-64 points. More preferably, equal to or between 8-32 points, and even more preferably, equal to or between 10-24 points, such as 10, 12, 13, 15, 16, 18, 19, 20, 22 or 24 points (or other points within such ranges).

The detection process begins with capturing an image of a printed document to be authenticated. This capture is performed using an optical imaging device with sufficient resolution to preserve the high-frequency components in an original document. It is preferable that the optical capture process used for authentication does not severely attenuate the high frequencies that are being measured. The attenuation is most likely due to printing on a low-resolution printer.

Once the image is captured, the digital watermark detector processes the image to detect the digital watermark signal. From this detection, the system determines a base orientation (e.g., rotation, scale, and translation) of the document in the captured image. This orientation information is used for the subsequent analysis of the high-frequency auxiliary signals, as their measurement can be impacted by misalignment. After orientation, the system examines specific locations in the frequency domain where the auxiliary signals were embedded in the original digital artwork for the printed document. The amplitude measurements at these high-frequency locations are compared to expected values for an original document. In a copy, these high-frequency components will be significantly attenuated compared to the original. In an alternative implementation, the amplitude measurements for all the auxiliary signals are added together and then averaged or normalized. This value is measured against a threshold or other established value associated with an original document. If the value is off by a percentage or amount, the document is considered a counterfeit. Otherwise, a comparison can be made between a value associated with the auxiliary signals.

Such a comparison may take several forms. For example: 1. Threshold comparison: Measuring whether the amplitude or other values at high-frequency locations exceeds a predetermined threshold. 2. Relative comparison: Comparing a ratio of high-frequency amplitudes to amplitudes of the digital watermark synchronization component. 3. Pattern analysis: Examining the pattern of attenuation across multiple high-frequency locations. 4. Statistical analysis: Applying statistical tests to the distribution of high-frequency components.

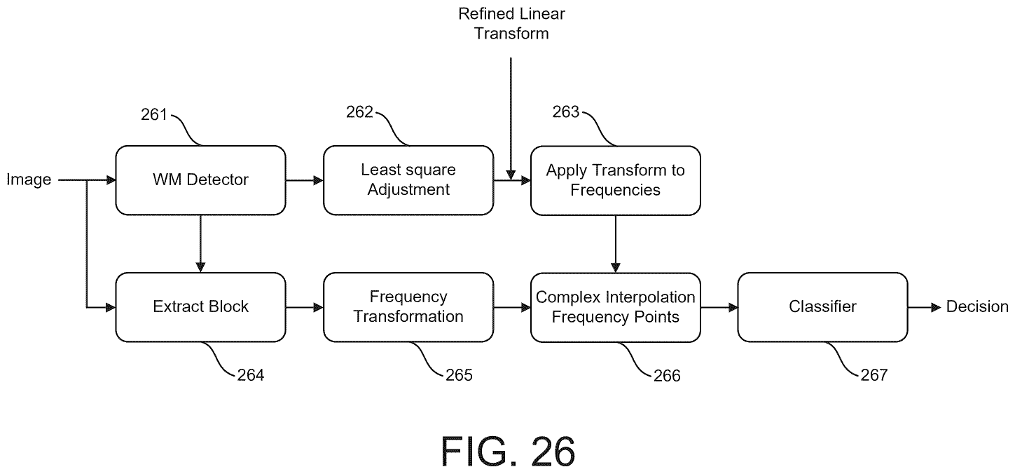

FIG. 26 illustrates a flow diagram for one embodiment of the authentication technology using frequency detection. The process proceeds as follows: A high-resolution optical image (“Image” in FIG. 26) depicting a printed document to be authenticated is captured. The printed document includes a digital watermark embedded therein, e.g., including an explicit synchronization component as discussed above. This image capture is preferably performed using an imaging device with sufficient resolution to preserve high-frequency components if they are present. Many of today's smartphone cameras of capable of such resolution, e.g., the Apple iPhone 16 and the Samsung Galaxy S25, etc. The captured image is analyzed by a digital watermark detector 261 to detect a digital watermark signal depicted in the imagery (as carried by the printed document). Digital watermark detection includes determining orientation parameters (e.g., rotation, scale, and/or translation) that will be needed for frequency analysis. For example, the captured image is oriented to a normalized reference frame. This ensures that the frequency analysis will examine the correct locations where the auxiliary signals were embedded.

The determined orientation can be refined even further using, e.g., a Least Squares Adjustment 262. Examples of least squares refinement can be found, e.g., in assignee's U.S. Pat. No. 11,410,262, which is hereby incorporated herein by reference in its entirety. The Least Squares Adjustment 262 yields a refined transformation (e.g., a refined linear transformation) to further adjust orientation of the captured image. This will allow for even tighter alignment and orientation of the auxiliary signal(s) associated frequencies 263 and frequencies associated with the synchronization component.

The digital watermark detector provides information regarding likely signal locations within the captured image. For example, a so-called fidelity point (or anchor point) is determined. A fidelity point may include a point where signal strength, signal characteristics, image characteristics, etc. indicates an image area having a likelihood of success for signal detection. Fidelity points are described in detail, e.g., in assignee's U.S. Pat. No. 11,250,535, Section V, said patent is incorporated herein by reference in its entirety. An image block or signal tile (or block center or tile center) is extracted 264 from or around the fidelity point identified by the digital watermark detector. The block is transformed 265 into a transform domain (e.g., via a Discrete Fourier Transform (DFT), often implemented using the Fast Fourier Transform (FFT)). Images can be readily transformed using a 2D FFT. For example, a 64×64, 128×128 or 256×256 FFT transforms the block of image data to reveal, e.g., frequency information associated with the auxiliary signals and synchronization component.

An interpolation (e.g., a complex Bilinear interpolation) 266 of the FFT can be performed to refine the frequency results. This technique is particularly useful because it lets one work with fractional frequency bins or create smooth transitions between discrete FFT samples. For example, it allows frequency estimates between FFT bins and is useful for precise frequency peak or location detection. At this point the FFT data can be refined according to the refined transformation 263 so that frequencies associated with the auxiliary signal and synchronization component can be accurately located.

The process determines values of magnitude (or amplitude) at specific frequency locations associated with the auxiliary signals. It can also determine the magnitudes (or amplitudes) of the digital watermark signal components to serve as reference values, ratio values or other comparison. In the illustrated flow diagram, the determined values are provided to a trained classifier (e.g., a binary classifier) 267 to decide whether the printed document depicted in the captured image is authentic or a copy. For example, the classifier 267 can be trained on thousands of images representing copies and authentic printed documents. A vector of values representing both the auxiliary signal(s) and the synchronization component, plus a label (Copy or Authentic) per vector, can be used to train the classifier. Said values can be obtained using the process described in FIG. 26, modules 261-266. Example classifiers include, e.g., G-Boost Classifier (Gradient Boosting Classifier), Logistic Regression (e.g., using a sigmoid function to model probability of binary outcomes), Support Vector Machine (SVM), Naive Bayes and Quadratic Discriminant Analysis (QDA). 1. Creating a dataset of both original documents and copies, all captured using an expected type or class of imaging devices. 2. Extracting feature vectors from each image, including frequency magnitude values of both the digital watermark synchronization component and the relatively higher frequency auxiliary signal(s). 3. Training a classifier to distinguish between originals and copies based on these features. 4. Validating the classifier on a separate test set to ensure its accuracy. Once trained, the classifier can make rapid determinations about whether a document is an original or a copy based on the extracted features. This approach can be more robust to variations in capture conditions than fixed threshold approaches.

In an alternative arrangement, a comparison module is utilized instead of the classifier 267. Magnitude values in the Fourier domain at frequency locations associated with the auxiliary signal(s) can be determined and used for comparison against a threshold or expected numbers. For example, the values of all (or a given subset of) frequency locations can be summed and compared to the threshold or expected number. Alternatively, values associated with the auxiliary signal(s) can be determined and compared with values associated with values associated with the synchronization signal frequencies. A ratio of the auxiliary signal values and the synchronization component values can be evaluated relative to a threshold or expected relationship.

In still another alternative implementation, a plurality of noise frequencies is embedded in the original artwork for the printed document. These plurality of noise frequencies are in addition to the high frequencies associated with the auxiliary signal and the synchronization component. The process discussed relative to FIG. 26 is adjusted so that values of the noise frequencies are also evaluated. The values have an expected value associated therewith, and values above such indicate noise. This determination can be used to adjust the auxiliary signal a synchronization signal frequency values to account for a noisy channel.

Of course, the process and technology described relative to FIG. 26 may also include additional modules for error correction, quality assessment of the captured image, and verification of the digital watermark payload against expected values. Furthermore, if no digital watermark is detected in module 261, the flow may terminate with a “copy” decision.

Of course, the relatively higher frequency components of the auxiliary signal can be integrated into or otherwise combined with the synchronization component. The relatively higher frequency components can be compared relative to components providing synchronization information.

### III. Digital Watermarking for Counterfeit Deterrence of Printed Objects

This Section III describes, e.g., digital watermarking for counterfeit deterrence of printed objects. Some printed objects include, e.g., product packaging, tickets, gift cards, tax stamps, certificates, visas, driver's licenses, identification documents, passports, banknotes, labels, stickers, cardstock, product collateral, proof of ownership, checks, bonds, stock certificates, promissory notes, money orders, promissory notes, deeds and title documents. One implementation utilizes a mixture of ink and topcoat (e.g., gloss, varnish, lacquer or other topcoat) as a carrier of a digital watermark signal.

Digital watermarking technology provided by the assignee, Digimarc Corporation, is currently being used in the retail and packaging industry, and by major brands. In the retail and packaging industry, substrates such as paper, opaque plastic, and foil with a flood of white ink can be used.

We have found that digital watermarking detection rates can be predicted using a 45/0 spectrophotometer to measure ink contrast. These spectrophotometers are widely used in the printing industry and are one method that is used on press for confirming the predicted robustness of digital watermarking. Signal encoding and robustness prediction is discussed, e.g., in U.S. Pat. Nos. 9,690,967 and 10,217,182, and in published US Patent Application No. US 2021-0110505 A1, which are each hereby incorporated herein by reference in its entirety.

Digimarc is extending the use of its digital watermark technology to the recycling industry. The recycling industry application requires digital watermarking to be applied to a larger range of substrates than in the retail and packaging industry. Two substrates that are widely used in the recycling industry and that were not previously supported are bare plastic bottles (plastic bottles without labels) and bare foil (foil without a flood of white ink). Some of our work in watermarking for recycling is found in, e.g., U.S. patent application Ser. No. 17/214,455, filed Mar. 26, 2021 (published as US 2021-0299706 A1), and published US Patent Application No. 2022-0331841 A1, and PCT international patent application No. PCT/US21/24483, filed Mar. 26, 2021 (published as WO 2021/195563), each of which is hereby incorporated here by reference in its entirety.

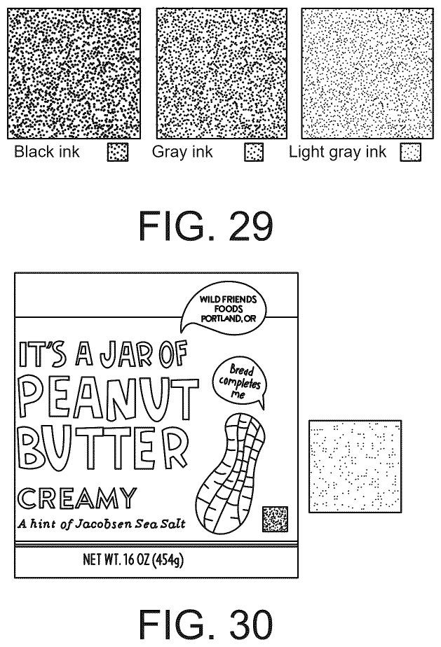

A few observations:
1. Bare plastic bottles have digital watermarking applied using various types of plastic blow mold techniques to introduce a texture which carries the watermark signal.
2. A bare foil substrate can include digital watermarking that applied using a binary watermark printed with solid ink or varnishes to introduce a texture. Digimarc's Binary Mark watermarking technology (also called “sparse mark” watermarking technology) is described in, e.g., US 2016-0275639 A1, US 2019-0171856 A1, and US 2019-0332840 A1, and in WO 2019/165364, and in U.S. patent application Ser. No. 16/849,288, filed Apr. 15, 2020 (U.S. Pat. No. 11,568,165), each of these patent documents is hereby incorporated herein by reference in its entirety including all drawings and any appendices. Additional examples of so-called sparse marks are shown in FIG. 29, in differing shades of ink. FIG. 30 shows an exploded view of a sparse mark printed with a spot color ink, PMS 9520.

In both of the above cases 1 and 2, the highest contrast seen by commercial capture devices is in the specular region.

We would like to predict the robustness of the digital watermarking on these substrates, for commonly used capture devices such as recycling scanners, mobile phones and Point of Sale Scanners.

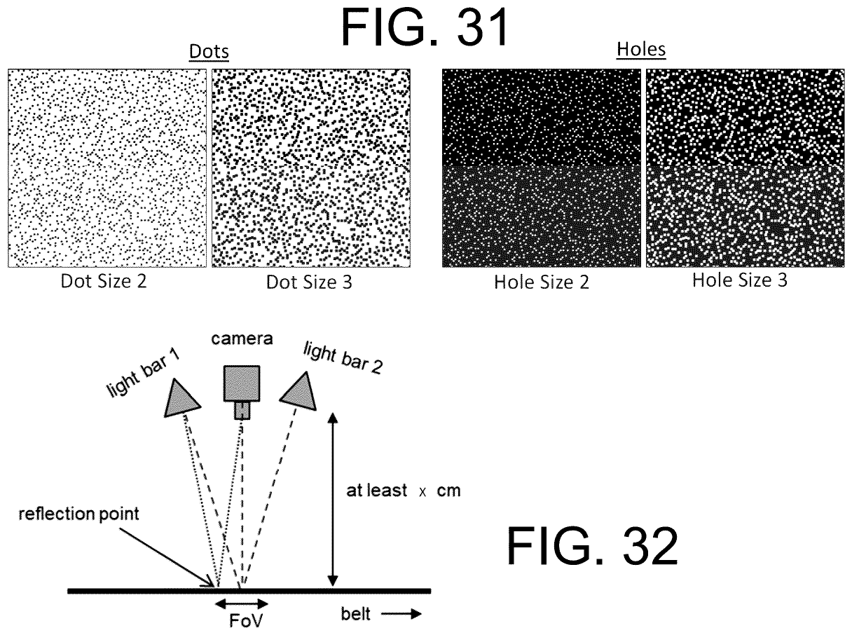

There are advantages to modulating clear topcoats, e.g., a varnish, to carry a sparse mark signal. For example, a varnish does not affect package color, it typically only affects the “glossiness” of a covered package area. Varnish can also be applied to a substrate using dots or holes. (For example, please see FIG. 31, where four different density sparse mark patterns are illustrated using matte and gloss varnish, together with a region with 0% varnish and 100% varnish. The black regions in these printed images contain varnish and the white does not. The larger the dot size, the larger the hole or dot. In this example, dot size 3 includes twice the surface area as dot size 2.) And contrast seen by a capture device between the varnish and the substrate is a measure of the watermark robustness.

We are investigating whether hand-held measurement devices are available, that will provide a measurement correlated to the contrast seen such capture devices in the specular region. If a standard device was available, it could be used to confirm predicted watermark robustness by measuring the relative gloss of reference patches created when a plastic bottle is formed, or relative gloss of printed reference ink/varnish patches. A hand-held gloss meter, GM-268 from M&A Instruments, can be used to obtain a Gloss Value. This GM-268 meter is designed and manufactured in accordance with the standard ASTM D523. The meter comes with a calibration standard which was regularly checked, and the samples were cleaned and placed on a flat surface for measurement. In one test preformed, a “Gloss Value” of each of the patches plus bare substrate and varnish flood was measured. While the gloss meter supports gloss measurements at 20, 60 and 85 degrees, the 85-degree gloss angle setting was used for all measurements to avoid saturation of Gloss Value on shiny substrates like foil.

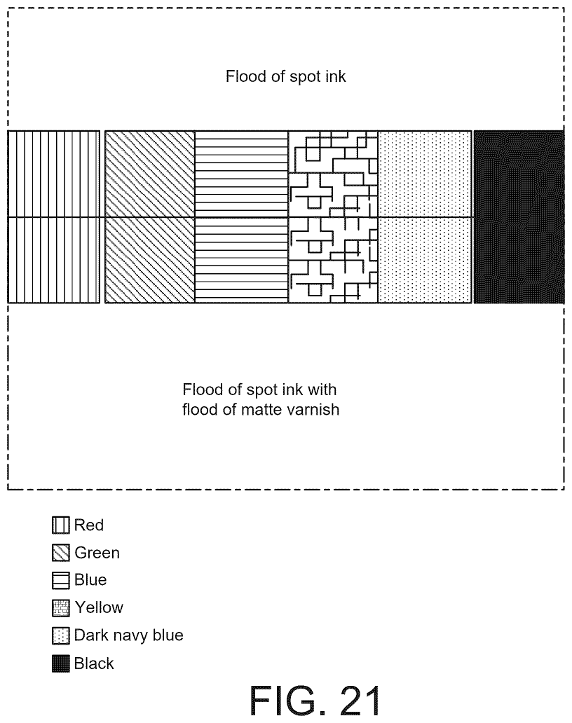

FIG. 21 shows 6 inks; the top row includes just a flood of the ink, and the bottom row includes a flood of ink covered by a flood of matte varnish. For each patch of ink, we measured the Gloss Value at several locations. The measured Gloss Value stayed relatively constant within a patch. We additionally measured contrast of each of the patches using Digimarc Corp's “recycling scanner” as generally modeled in FIG. 32. The scanner includes a monochrome camera, e.g., with a 12-bit output and linear response to captured light, two light bars for illumination and a flat sample bed. The light bars are off axis to the camera by 10-25 degrees, and light bars contain rows of blue and LEDs. The LEDs are pulsed on, in sync with the camera system to sequentially capture blue and red frames. The camera and light bars are set to a distance X cm (or inches) above the sample bed for a desired Field of View (FoV). Printed images were captured at the same image location on the recycling scanner. The average gray level with red illumination was measured at the same position in the scan frame. The average gray level of each of the patches plus bare substrate and varnish flood was also measured.

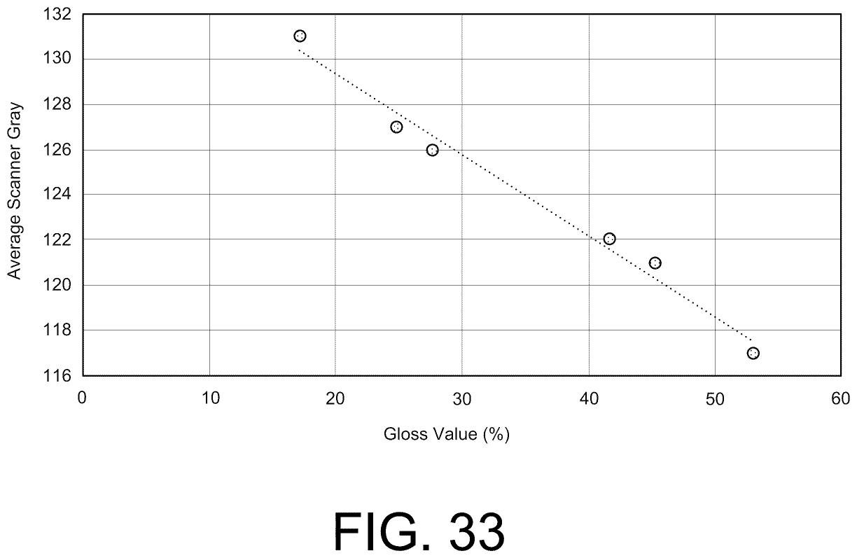

FIG. 33 shows a plot of recycle scanner gray value versus gloss value. There we see that with matte varnish on opaque white plastic substrate; the Gloss Value correlates well with Average Scanner Gray levels in a linear manner. This shows that we compare gloss value to digital watermark robustness, due to a direct relationship between digital or reflectance contrast (e.g., as measured by differences in the scanner gray values or reflectance percentages) and watermark robustness. For example, a higher contrast between a watermark carrier (e.g., cyan ink) and white substrate correlates to a higher signal robustness. Similarly, a lower contrast between a watermark carrier (e.g., yellow ink) and yellow substrate correlated to a lower signal robustness.

Next, in FIG. 17A, we plot Gloss Value vs. average matte varnish coverage over an opaque white plastic. 0% varnish in FIG. 17A represents bare substrate (no matte varnish) and 100% varnish is a flood. Different dot and hole sizes have different matte varnish coverage over a substrate (or over gloss varnish layer). Similarly, in FIG. 17B we plot Gloss Value vs. average gloss varnish coverage over an opaque white plastic substrate. In particular, different dot and hole sizes have different gloss varnish coverage over a substrate (or over a matt varnish layer).

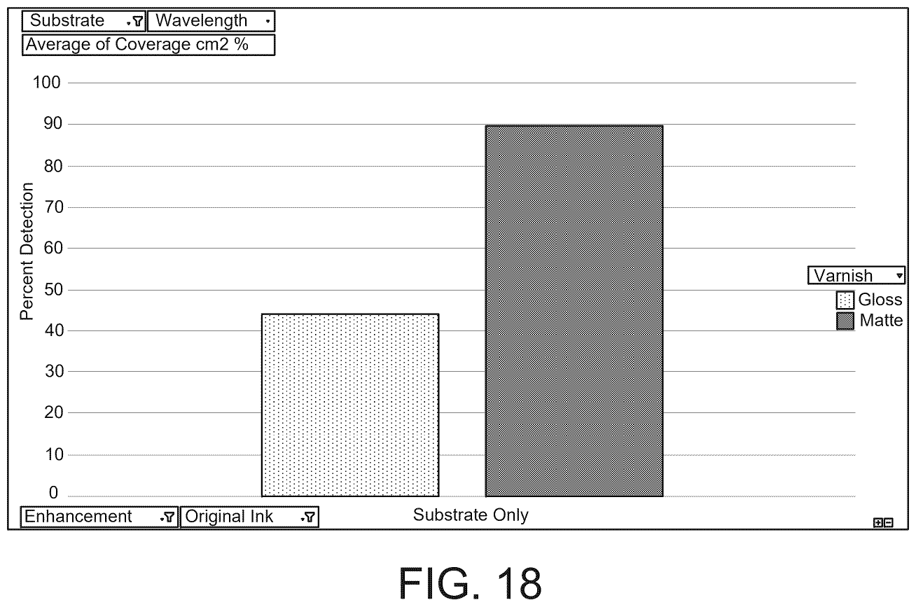

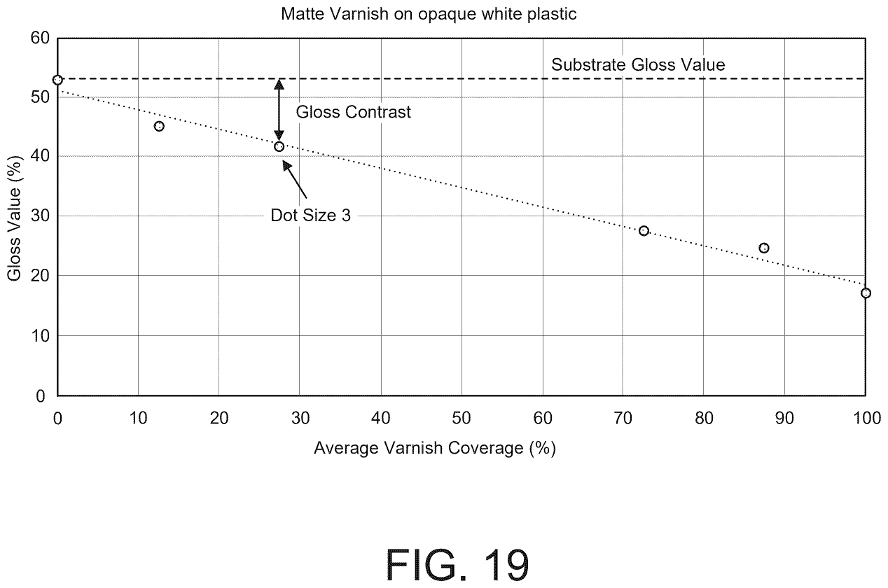

As shown in FIGS. 18 and 19, we have found that matte varnish has a higher gloss contrast on opaque white plastic substrate than the gloss varnish. (FIG. 18 shows watermark robustness carried by gloss and matte varnishes on an opaque white substrate. Robustness values are shown for Dot Size 3; the Y axis is watermark detection percentage; the X axis shows gloss (left bar) and matte (right bar). FIG. 19 shows Gloss Value contrast for matte varnish on an opaque white substrate. At dot size 3, the gloss contrast between the opaque white substate and the matte varnish is about 10-12%.) This results in a higher contrast watermark signal when modulating matte varnish vs. gloss varnish. A higher contrast signal results in greater watermark robustness and leads to better payload decoding results.

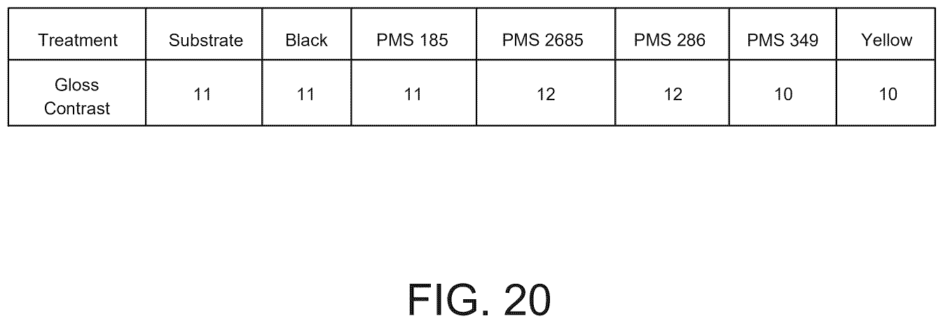

With reference to FIG. 20, several different flood spot colors were overprinted with a matte varnish at 27% coverage. The expected gloss contrast between the substrate and the watermarked sample is an indication of whether the varnish dots were printed correctly. Lower gloss contrast means varnish dots are smaller than expected (or disappeared). Higher gloss contrast means dots are larger than expected.

Thus, we have found that measuring the Gloss Value of a flood of varnish on a substrate relative to a bare substrate is a good indicator of sparse mark robustness for a sparse mark carried by modulating varnish. This measurement can be used to predict signal robustness prior to printing. Additionally, the Gloss Value of the watermark pattern relative to a substrate or color provides a measure for print quality of the varnish dots. The watermark pattern contrast indicates varnish dots are printed correctly.

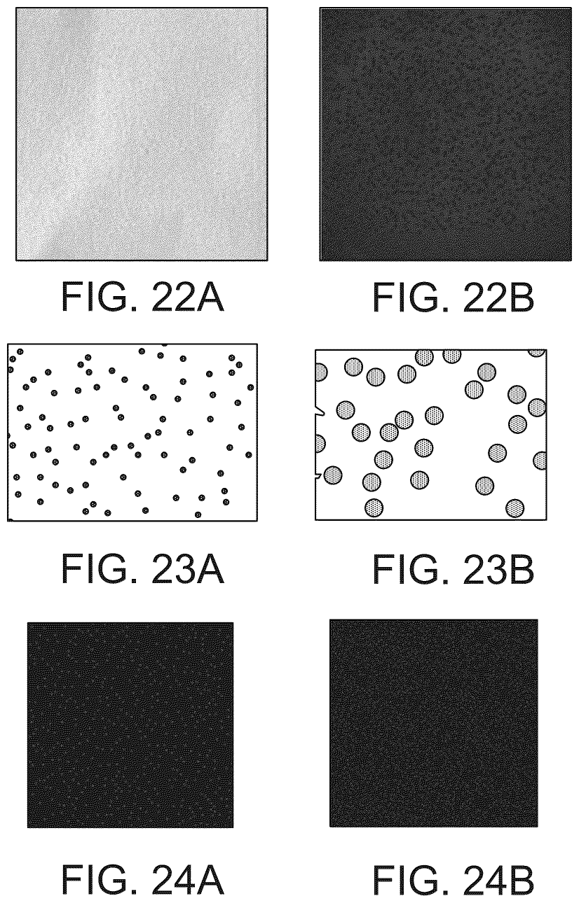

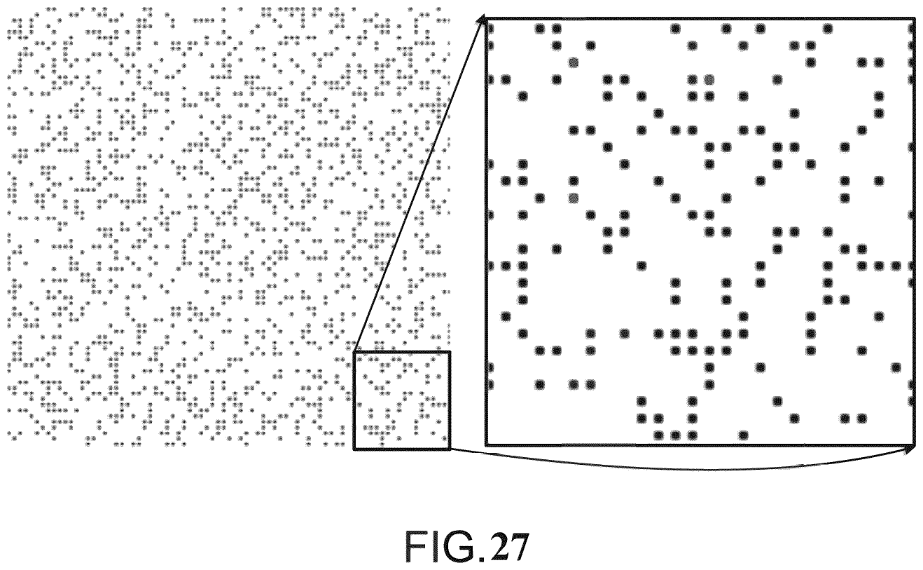

In another implementation, a watermarking signal that is measured correlates to the local contrast seen by the capture device as described below. The watermarking used for this implementation analysis includes a binary pattern of dots which is like a Frequency Modulated (FM) screening pattern (see FIG. 22). The FIG. 27 watermark signal is carried on a substrate by modulating a varnish applied to the substrate. The varnish is printed so as to include holes spatially arranged according to the illustrated FIG. 27 dots. In some cases, the varnish is printed over an ink, or directly onto a substrate, e.g., a foil.

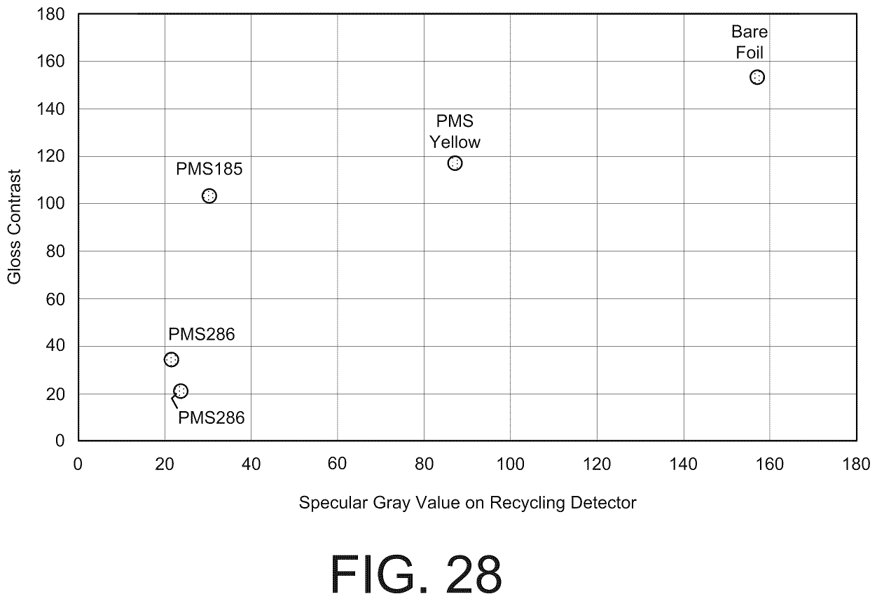

A gloss meter averages over a local area defined by the device aperture and measures gray values seen by an ideal capture device. Note that the measurement device aperture needs to be large enough that the pseudo-random watermark signal is averaged out, and the measured gloss value correlates to the gray value seen by a scanner which has a linear response to light (ideal capture device). The minimum aperture size is shown by the dark yellow box in FIG. 27. The gloss value stays approximately constant as the meter is moved to read different regions of a printed piece which has flat image content. Table 2 (FIG. 25B) shows gloss values measured from a piece of bare foil printed with floods of various colors. Column 1 lists the ink colors which are overprinted with a flood of matte varnish (column 3) and compared to a watermarked patch which contains a flood of the same color over-printed with matte varnish that has holes inserted (column 4). Note the black dots in FIG. 27 are the watermark signal that corresponds to holes in the flood of matte varnish. Column 5, which is the absolute value of column 4 minus column 3, is the gloss contrast. FIG. 28 is a plot of various contrast values as represented by scanner gray values (e.g., col. 6).

So, the Delta or gloss contrast (column 5) is what a gloss scanner would see from the dots in FIG. 27. If the contrast is sufficient, the watermark will read with sufficient robustness to yield a decodable payload. The contrast is correlated to robustness to determine a predictive model for watermark signal detectability. Moreover, a correlation between gloss contrast and scanner gray value can lead to a prediction of signal robustness from a detected gray value. In Table 2, rows 2 (Bare Foil), 3 (PMS 185) and 6 (PMS Yellow) each have sufficient gloss contrast for signal detection. A threshold at or above say 75-100 grey value could be correlated to allow robustness prediction on a scanned gray level value. (In fact, a much lower gloss contrast allows for prediction, so a lower grey level threshold value could alternatively be used, e.g., above 50, or about 60 or in a range of at or above 50-100.)

Returning to digital watermarking for counterfeit deterrence of printed objects, please consider the following implementations:

I. An encoded signal is printed over, under and/or within print elements printed with so-called Optical Variable Ink (OVI). OVI is a security feature that can be used for printing objects. Such ink may display a plurality of colors, e.g., two or more distinct colors depending on the viewing angle. The color shift occurs due to the interaction of light with a structure of the ink, typically involving several layers of thin-film interference. For example, OVI may include multiple thin layers of inorganic oxides, e.g., like titanium dioxide or iron oxide. Each layer has a different refractive index and thickness, creating constructive and destructive interference in reflected light, which can result in different colors being visible at different viewing angles. An example manufacturing process may include, e.g., depositing two or more thin layers onto a carrier substrate via a high-precision technique such as physical vapor deposition (PVD). After deposition, the material can be processed into flakes, which are then suspended in a suitable solvent to form the ink. The OVI ink can be applied to a substrate using standard printing techniques, such as digital printing, silk screen, offset, flexo, letterpress, and gravure (e.g., intaglio printing). See, e.g., U.S. Pat. Nos. 6,521,036, 7,029,525, 8,067,090, 6,485,556, 6,596,070, 6,689,205, 6,884,289, 5,607,504, 5,624,486, 6,783,584, 5,135,812, 6,686,042, 6,521,036, for additional details on OVIs. Each of these US Patents are hereby incorporated herein by reference in its entirety.

In this first (“I.”) implementation, a print element, e.g., a graphic, design, number, character, flood, etc., is printed using an OVI, yielding an OVI print element. In a first example, the OVI print element is printed so as to include a plurality of holes (e.g., spaces without OVI ink). FIGS. 24A and 24B are different examples of a portion of an OVI printed element (black) including different patterns of plurality of holes (shown as purple). This particular OVI material shifts between black and a second color (e.g., red, green or blue or other color depending on material composition) depending on viewing angle. The plurality of holes can be arranged, e.g., according to one or more encoded signals. One example of an encoded signal is the above-mentioned sparse mark digital watermark signal carrying a plural-bit message or payload. Examples of such are found in assignee's patent documents including, e.g., US 2016-0275639 A1, US 2019-0171856 A1, and US 2019-0332840 A1, and in WO 2019/165364, and in U.S. Pat. No. 11,568,165, which are each incorporated herein by reference in its entirety. The size of the holes can vary of course, e.g., from 0.04 mm-0.4 mm, and more particularly, from 0.07 mm-0.25 mm, and even more preferred from 0.1 mm-0.2 mm. Similarly, the density of the holes in an encoded signal can vary from sparse (FIG. 24A) to dense (FIG. 24B) with a denser configuration yielding a more robust signal at the cost, e.g., of signal visibility. The holes can be left unfilled, e.g., to reveal an underlying substrate color or underprinted ink color (as illustrated, purple; but other colors could be used). A reflectivity contrast difference between the hole color and the OVI printed element can be detected by a signal detector. A corresponding signal can be detected using the technologies discussed in Section I and in the incorporated by reference patent documents. In a second example, the holes within the plurality of holes are filled with a color ink and/or topcoat. For example, the holes may receive an overlay of ink or varnish (equal to or overprinted with a trap of a 1-4 pixel width). The goal is to reduce visibility of the holes vs. the OVI print element but still maintain a reflectivity difference between the two (overly of ink or varnish vs. the OVI print element) that is detectable. We have found that a reflectivity difference of 8%-50% can satisfy this goal. In an even more preferred case, a reflectivity difference of 12%-25% is achieved. In a third example, an encoded signal, e.g., arranged in a 2D pattern such as is provided by a sparse mark digital watermark pattern, is first printed on a substrate and then the OVI print element is printed over the sparse mark pattern (e.g., using a plurality of dots or other print structures). The dots or other print structures can be printed using a color (e.g., white) that has a different reflective property relative to the substrate. This way, a reflectivity difference between a layer of OVI/dot/substrate has a different reflective vs. a layer of OVI/substrate. Again, a reflectivity difference of 8%-50% may yield balance between detectability and visibility. In an even more preferred case, a reflectivity difference of 12%-25% is achieved. In a fourth example, an encoded signal, e.g., arranged in a sparse mark digital watermark pattern, is printed over an OVI print element in a sparse mark pattern (e.g., using a plurality of dots or other print structures). The dots or other print structures can be printed using a color (e.g., white, yellow or purple) that has a different reflective property relative to the OVI/substrate. This way, a reflectivity difference between a layer of dot/OVI/substrate has a different reflective vs. a layer of OVI/substrate. Again, a reflectivity difference of 8%-50% may yield balance between detectability and visibility. In an even more preferred case, a reflectivity difference of 12%-25% is achieved.

Printed object authenticity can be determined by a successful decode of an encoded signal plural-bit message or payload, coupled (optionally) with detection of two color detections resulting from different viewing angles of the OVI print element. A mobile app can be configured to control a camera on a smart device such as an iPhone or Android based device. The camera captures imagery depicting the OVI print element. A signal decoder, e.g., a digital watermark decoder, analyzes captured imagery to decode the plural-bit message or payload conveyed by the plurality of holes. The decoded plural-bit message or payload can be provided to a database housing information associated with the printed object. The housed information can be analyzed to determine whether it corresponds to the printed object in an expected manner, e.g., via type of object (user input or machine determined), location of object (based on smart device GPS coordinates or user input coordinates vs. expected geography), date of scan vs. physical object printing). The mobile app can also determine if the OVI provides two colors at different viewing angles, e.g., by prompting the user to move the object or camera relative to one another. Captured imagery can be monitored to see if two different colors are found within the OVI (e.g., by monitoring captured color values from the smartphone's image sensor to see a shift in black to red, or black to green, and so on). For example, current camera sensors use, e.g., a Bayer filter, to filter captured image data from an image sensor. This filter is placed over the sensor and consists of a repeating pattern of red (R), green (G), and blue (B) filters. The most common arrangement is 50% green, 25% red, and 25% blue, reflecting the human eye's greater sensitivity to green light. An app running on the smartphone can monitor RGB output to determine a color change from black to say green. A user can also or alternatively input (e.g., tap a GUI presented on the smartphone's screen) a noticed color change with viewing angle.

II. An encoded signal is printed using a mixture of white ink and varnish. For example, gloss or matte varnish. In this second (“II.”) implementation, we utilize a mixture of white ink and varnish to carry an encoded signal. For example, a 50%-70% (by weight or volume) white ink and 50%-30% (by weight or volume) gloss varnish mixture or a 55%-65% (by weight or volume) ink and 45%-35% (by weight or volume) gloss varnish mixture is utilized. Some specific example mixtures include 50% ink/50% gloss varnish, 55% ink/45% gloss varnish, 60% ink/40% gloss varnish, 65% ink/35% gloss varnish, 70% ink/30% gloss varnish; of course, other example mixtures will fall within the above ranges of white ink/gloss varnish. We have found that more white ink vs. varnish work better, e.g., higher white volume vs. varnish volume. Dots or other print structures are arranged according to a 2D encoded signal pattern and then printed on a printed object. One example of a 2D encoded signal pattern is a sparse mark digital watermark as described above. Another example of a 2D encoded signal pattern is a deep learning generated encoded signal created using, e.g., neural networks such as convolutional neural networks (CNNs).

FIG. 22A shows a substrate that is printed to include a 2D pattern carried by an ink/varnish mixture. The mixture includes a 60% white ink/40% gloss varnish mix. Under white light, the mixture/substrate layer has a reflectivity difference relative to just the substrate, with the mixture appearing lighter than the substrate. A reflectivity difference equal to or between 8%-50% may yield a balance between signal detectability and visibility. In an even more preferred case, a reflectivity difference equal to or between 12%-25% is achieved. Interestingly, under UV illumination of the printed substrate including the white ink/gloss varnish mixture (or “white dots”) of FIG. 22A, the plurality of white dots carrying the 2D pattern appear darker relative to the substrate. See FIG. 22B. For our purposes, UV illumination includes a wavelength, e.g., equal to or between 300 nm-400 nm, such as an illumination source having a peak illumination at 365 nm or at between 390 nm-400 nm, or another peak illumination within the 300 nm-400 nm range. This provides a counterfeit detection mechanism since the white dots (or other print structures such as lines or hashes) either appear lighter (under white light illumination) or darker (under UV illumination) relative to the substrate. For example, consider a signaling scheme where a light contrast corresponds to a positive signal change (or tweak), and a darker contrast corresponds to a negative signal change (or tweak). A “tweak” here refers to an image change (e.g., a pixel value change or color value change, or reflectivity difference change) needed to carry a signal component. This shift between light and dark creates a signal polarity shift. In one example, one or more dots represent a “1” value under a light contrast, but the same one or more dots represent a “−1” (or “0”) value under a dark contrast. This creates a signal polarity shift. A decoder (or cooperating mobile authentication application) can be configured to require a first signal polarity detection (e.g., including a successful message decode) under a first illumination condition (e.g., under white or ambient light) and a second signal polarity detection under a second illumination condition (e.g., under UV illumination), e.g., including a successful message decode. See assignee's U.S. Pat. No. 11,560,005, which is hereby incorporated herein by reference in its entirety, for a description of signal polarity shifting under flash illumination.

III. This implementation addresses encoded signals and holograms. In a first example, an encoded signal is printed using yellow ink (e.g., yellow process ink) over an optically varying device (OVD) such as a hologram. By way of context, holograms are based on the principles of holography, which involve recording and reproducing three-dimensional light fields. Various types of holograms include, e.g., 2D/3D Holograms: These holograms contain multiple two-dimensional layers with visual depth, which give the appearance of three-dimensional structures at different levels. The layers are visible from various angles. Dot Matrix Holograms: Produced by creating a series of dots that diffract light, these holograms can display complex animations and effects when viewed under light. Stereograms: These are made from a series of photographs of an object from different angles, which are then combined into a single hologram that shows a 3D effect when tilted. Color shifting: Some holograms are designed to include color-shifting images that change color depending on the viewing angle, further complicating attempts at reproduction. Example manufacturing techniques include: Embossing: Many security holograms are mass-produced through a process called embossing, where the holographic image is transferred from the master hologram onto nickel shims, and then pressed onto foil or directly onto the security document. Such hologram may include an adhesive layer to securely bond it to the paper or plastic substrate of the document.

Returning to the first example, with reference to FIG. 23A, yellow dots are arranged in a pattern over a hologram. The plurality of holes can be arranged, e.g., according to one or more encoded signals. One example of an encoded signal is the above-mentioned sparse mark digital watermark signal carrying a plural-bit message or payload. Examples of such are found in assignee's patent documents including, e.g., US 2016-0275639 A1, US 2019-0171856 A1, and US 2019-0332840 A1, and in WO 2019/165364, and in U.S. Pat. No. 11,568,165, which are each incorporated herein by reference in its entirety. The size of the signal carrying dots can vary of course, e.g., from 0.04 mm-0.4 mm, and more particularly, from 0.07 mm-0.25 mm, and even more preferred from 0.1 mm-0.2 mm, for example, 0.125 mm, 0.15 mm, 0.18 mm, or other value between 0.1 mm-0.2 mm.

One advantage of using yellow ink as an encoded signal carrier is that dot reflectivity may change as the viewing angle changes resulting in a perceived different color within the hologram. A color-shifting effect can be achieved, e.g., by engraving microscopic grooves or holographic pixels into the hologram's surface. These grooves are precisely spaced and often have varying depths and shapes. This variation changes the angle at which light is diffracted after hitting the surface. The spacing of the grooves determines the wavelength of light that is predominantly diffracted. Smaller spacings diffract shorter wavelengths (blue light) more, and larger spacings diffract longer wavelengths (red light). When white light (which contains all colors of light) hits the hologram, each color is diffracted at a slightly different angle due to its wavelength. As a viewer's angle relative to the hologram changes, a color seen changes because different parts of the light spectrum are being directed towards the viewer's eyes. As the viewer moves or tilts the hologram, the angle of light incidence changes, altering the diffraction angles and thus changing the color composition that reaches your eyes. Some holograms include multiple layers, each contributing to the diffraction and providing a more complex color shift pattern. Other holograms might use materials with unique optical properties (e.g., metamaterials) to manipulate light in sophisticated ways, enhancing the visibility and distinctiveness of the color shift image difference from hologram.

Hologram reflected light at different angles combined with that from the yellow dots may effect a contrast between the dots and hologram. This difference can be measured at different angles. Detector (or an app working in cooperation with a detector) may require encoded signal capture at different angles. Detected signal strength metrics at different angles can be compared to determine whether an expected (or relative) variation is found. Example signal detection metrics can be based on the detectability measures described in assignee U.S. Pat. No. 11,188,997, which is hereby incorporated herein by reference in its entirety. If so, a printed object including an encoded hologram (e.g., a hologram overprinted with an encoded signal) can be deemed authentic. If not, the

In a second example, a hologram—itself—is created to include an encoded signal therein. The encoded signal only appears under specific lighting conditions or angles, or when using special viewing devices. For mass production, a master hologram including the encoded signal can typically transferred to, e.g., shim via electroforming, and this shim can be then used to emboss the holographic pattern onto metallic foil sheets or directly onto printed object. This embossing replicates angle-dependent visibility characteristics of the master hologram. A digital copy of the hologram may not have been taken at the right viewing angle so that the encoded signal will not be found therein. Failure to detect an encoded signal within the digital copy indicates a counterfeit.

In a third example, an encoded signal within a hologram only includes a first signal component, e.g., a synchronization component, as discussed above in Section I. The first signal component is only viewable at a first angle. A second signal component, e.g., a payload or message component, is then applied to the hologram during a printing stage. The second signal component is applied in alignment with the first signal component so that when the first signal component is viewed at the first angle it enables detection and reading of the second signal component. But, since the first signal component is viewable only at the first angle, a digital copy of the hologram (including the first and second components) will likely not be taken at the first viewing angle, so the first signal component will not be captured in the digital copy. This will not enable the second signal component to be detectable, even if reproduced in the digital copy. Failure to detect the encoded signal in such a case indicates a counterfeit. See assignee's PCT Patent Application No. PCT/US25/027131, filed Apr. 30, 2025, which is hereby incorporated herein by reference in its entirety, for a discussion of separating first and second signal components on different layers. For example, see FIGS. 8A-8C and related discussion in the PCT/US25/027131 application.

In a fourth example, we use lenticular lens structures to establish a viewing angle at which an underprinted encoded signal is detectable. Although technically not a hologram, lenticular lens structures can be used as an alternative to holograms in this implementation III. Lenticular images rely on physical geometry and optics of the lenses, rather than the wavefront reconstruction used in holography. Lenticular lens sheets are typically plastic sheets containing a series of convex lenses or lenticules on one side and a flat surface on the other. Each lenticule magnifies and displays a small portion of the image beneath it, depending on the viewing angle. Lenticules are typically cylindrical and run parallel to each other across the sheet. Orientation and curvature of these lenses dictate the angle at which images (e.g., an encoded signal arranged in a 2D pattern) beneath them are visible. Multiple images are digitally sliced into narrow strips and interlaced in a precise order. This composite image is then printed directly beneath the lenticular lens sheet. Each strip aligns with a corresponding lenticule. As a viewer changes their angle of viewing relative to the lenticular print, different strips of the interlaced image are visible through the lenticules. This change is due to light refracting differently through the lenticules, which exposes different parts of the underlying image. A digital copy of the lenticular lens structure may not have been taken at the right viewing angle so that an encoded signal underneath will not be replicated. Failure to detect an encoded signal within the digital copy indicates a counterfeit.

IV. In this implementation IV, a so-called fingerprint (e.g., a reduced-bit representation of media) or other characterization is created based on print structures carrying a printed digital watermark. That is, we are not concerned with image content for a fingerprint but rather wish to fingerprint or characterize print structures that only represent the digital watermark signal. The fingerprint can be generated, e.g., after printing on a physical object and prior to distribution. This generated fingerprint can be stored in a data repository and associated with a payload carried by the digital watermark. To determine authenticity of the printed object, a detector analyzes captured imagery depicting the digital watermarking. The detector decodes a payload and queries a data repository with such to obtain a corresponding fingerprint. A fingerprint generator generates a fingerprint of print elements conveying the digital watermark from the captured imagery and compares such to the obtained corresponding fingerprint. If they match (or otherwise correspond in an expected manner), the printed object is considered authentic. If not, the printed object is considered fake or at least suspect.

One example of a digital watermark signal is the above-mentioned sparse mark digital watermark signal carrying a plural-bit message or payload. Examples of such are found in assignee's patent documents including, e.g., US 2016-0275639 A1, US 2019-0171856 A1, and US 2019-0332840 A1, and in WO 2019/165364, and in U.S. Pat. No. 11,568,165, which are each incorporated herein by reference in its entirety. In this context, consider FIG. 23B. A fingerprint can be generated to characterize size, shape, edginess and/or relative positioning of the print structures (e.g., dots or other elements). If the digital watermark includes a synchronization component, it can be used to resize the image data to a base state so that any resulting fingerprint will be calculated at the same resolution as the original fingerprint.

Of course, the data repository housing the original fingerprint can be locally stored but is most preferred to be remotely accessible, e.g., via a cloud service interface. Pattern matching can be used to assess dot shape and/or relative positioning against a master template, looking for shape deformation or pattern skewing. Some examples to locating and characterize a pattern of dots include, e.g., morphological operations (dilation and erosion), connected component labeling, blob detection (e.g., Laplacian of Gaussian, Difference of Gaussians, and the determinant of the Hessian matrix), edge detection (e.g., Sobel, Canny, or Prewitt edge detectors), and/or Hough Transform. Once a pattern is identified, its print element edges, relative spatial positioning, etc. can be characterized and used as a fingerprint.

Additionally, digital watermark signal detection metrics can be determined when enrolling each physical object. For example, at the time of generating an original fingerprint of the digital watermark signal (or, rather, of the print elements carrying the signal), a digital watermark detector generates detection metrics associated with a detection of the digital watermark signal. Example signal detection metrics can be based on the detectability measures described in assignee U.S. Pat. No. 11,188,997, which is hereby incorporated herein by reference in its entirety. Detection metrics are stored in the data repository with the original fingerprint, or instead of the fingerprint. We'll call these “original detection metrics”. The data repository may also include other information that may help determine authenticity (expected distribution channel, creation date, printed object type, authorized party, etc.). See Table 3 in FIG. 25C as an example.

Later counterfeit detection can access these original detection metrics using a corresponding detector and compare them to subsequently generated detection metrics to determine originals from counterfeits. For example, a copy of an original may have reduced detection metrics. A difference of greater that 10% may indicate a likely counterfeit attempt.

V. This implementation relies on a combination of security features. For example, the use of a combination of encoded signals found in Implementations I-IV above. For example, a printed object may include both an encoded hologram from Implementation III and a white ink/gloss varnish encoded signal as described in Implementation II, above. Moreover, additional combinations can be made using the following security features.

Line Modulation to carry encoded signals. A printed object may include a print layer with a plurality of lines and/or elements conveyed with line art (e.g., Guilloche patterns). An encoded signal can be carried through manipulation of the lines. For example, see U.S. Pat. No. 7,856,116, which is hereby incorporated herein by reference in its entirety, for a discussion of Line Width Modulation, Line Continuity Modulation, Line Angle Modulation, Line Frequency Modulation, and Line Thickness Modulation. Authentication is achieved when an encoded signal is detected from the line modulation. In a related implementation, an original fingerprint is generated of the modulated, printed lines. An authentication analysis regenerates a fingerprint of the modulated, printed lines and compares such with the original fingerprint. Authentication is determined through encoded signal detection and fingerprint analysis.

Encoded signals carried with Ultraviolet (UV) inks, Infrared (IR) inks or Optically Varying inks (OVI). Encoded signal can be printed using non-visible light inks. For example, Line Modulation elements can be printed with Ultraviolet (UV) inks. In particular, UV inks (or IR or OVI inks) are used to print modulations to lines. The modulations correspond to a 2D pattern representing an encoded signal. For example, lines are printed with a first ink and then overprinted with modulations with a UV ink. The modulations are not visible under ambient illumination. When exposed to UV illumination, the lines “grow” in certain areas corresponding modulations. The encoded signal is detectable from imagery depicting UV illuminated lines. A copy of this security feature under UV illumination would include the encoded signal. So, a reprint (counterfeit) would have this encoded signal detectable under ambient light. But the original would only reveal this encoded signal under UV illumination. Ultraviolet (UV) inks typically only become visible only under ultraviolet light. UV inks contain photoluminescent pigments that absorb light in the UV spectrum (e.g., wavelengths from 200 nm to 400 nm) and re-emit it in the visible spectrum when exposed to UV light. This process is known as fluorescence. Infrared (IR) ink contains pigments that absorb and reflect infrared light, typically wavelengths beyond the visible spectrum, at 700 nanometers (nm) and above. This makes IR ink undetectable under ambient or white lighting conditions. Typically, when illuminated with an infrared light source, IR ink absorbs the IR light and may also emit light at a different infrared wavelength, making it detectable with IR cameras or sensors. Optically Variable Ink (OVI) exhibits different colors depending on the viewing angle. OVI contains flakes of multi-layered thin-film structures that reflect light in specific ways. Flakes can be engineered to have physical properties, including thickness and refractive index, allowing them to reflect certain wavelengths of light more efficiently than others. This leads to the OVI ink appearing one color when viewed straight on and a different color when viewed at an angle.) Printing encoded signals with UV, IR or OVI inks is not limited to Line Modulation encoding. For example, a sparse mark digital watermark signal can be printed using an UV, IR and/or OVI ink.

Another security feature relies on varied dot size within an encoded signal pattern. For example, the above-mentioned Sparse Mark digital watermark signal includes a pattern that can be represented by printed dots. Dot size is varied within the pattern to include some relatively small dots. This creates a potential for certain copy paths (low resolution scanner and/or printer) to lose the smaller dots, eroding overall signal strength. The erosion may lead to a failure to detect, or to diminished detectability measures as described in assignee U.S. Pat. No. 11,188,997, which is hereby incorporated herein by reference in its entirety. Original detectability measures can be compared to subsequent detections to determine if the overall signal strength has been eroded beyond a threshold. For example, if eroded beyond 5-25% of the original detectability measures the questioned printed object is likely counterfeit. In addition, similar to above in Implementation IV, a fingerprint or pattern characterization can be generated based an expected pattern's dot structure (e.g., dot density, dot size, dot shape etc.). Dot shape, dot size, dot color are all variations that could be measured and characterized to determine authenticity. Such characterizations can be stored in a date repository and later accessed to compare against suspected fakes. (Here, as in some of the above implementations, an encoded signal may be robust to copy reproduction. For example, some digital watermarks may survive copy (e.g., with a scanner) and reproduction (e.g., with a printer). So a counterfeit may include a detectable watermark with a payload that can be used to access a data repository. But, the pattern's dot structure may not correspond to the originally stored information, indicating a fake.

Multifactor Authentication—A printed object includes one or more encoded signals, with each encoded signal carrying a payload. These payloads can collectively be combined or compared with one another and/or with other data carriers (2D barcode, DataMatrix, etc.) on the printed object. In a first example, a digital watermark payload includes a decryption key that unlocks an encrypted 2D barcode (or other code). A counterfeit copy may successfully copy the 2D barcode but might be unsuccessful in copying the digital watermark (e.g., perhaps it's carried by a UV ink as discussed above). In a second example, a printed object includes two or more digital watermark signals, each carrying a plural-bit payload. The payloads correspond to or otherwise complement one another in an expected manner. Successful authentication requires detection (and use) of both digital watermark signals' payloads. In a first case, the payloads must match or be cryptographically related in an expected manner. In a second case, the two or more payloads are concatenated and provided to an online service to retrieve complete authentication information.

Data-driven authentication can be used to determine authenticity. For example, a printed object includes a digital watermark printed thereon. In this security feature, the digital watermark is robust, so it will likely survive a copy and reprint. The digital watermark includes a payload that can be used to access an online repository including data associated therewith. Even a counterfeit will likely have a detectable payload in this implementation. The data stored within the repository can be used to identify suspicious activity indicative that the digital watermark may have been copied. For example, the data may include an expected distribution channel, expected consumer or customer location, number scans (e.g., incrementing a counter each time data is accessed, where a higher scan count indicates a counterfeit), location and spread of detection inquiries, etc. Counterfeits are determined when the data does not match a detection inquiry. For example, and reference to the above Table 3, the data may show that printed object associated with payload ID: 987654321 is expected to be distributed to Idaho, USA. If an IP address (or scan location) associated with an authentication inquiry is say, Brazil, then the item is likely a counterfeit.

A digital watermark may serve as a trigger to look for another security feature. For example, a printed object includes a digital watermark (with payload) and a second security feature. Detecting the digital watermark may trigger an app to search for the security feature. In one case, the app communicates a detected digital watermark payload to an online repository, which stores data therein that is associated with the payload. The data indicates that the app should look for a second security feature, which can be intentionally hard to duplicate. The second security feature may include, e.g., micro printing, an encoded signal, hologram, or even micro-optics. Micro-optic technology incorporates tiny lenses and microstructures to produce optical effects. For example, micro-optic structures may include an array of microscopic lenses or mirrors that are engineered and aligned with underlying graphical elements. When viewed from different angles or under different lighting conditions, micro-optic labels can display various effects, such as motion, depth, 3D images, and even flip images (where two or more distinct images appear alternately depending on the viewing angle), or images/text/2D codes. Detection of the digital watermark, but not the second security element indicates a fake.

White ink on White Paper. For some counterfeit workflows, white ink (as a digital watermark signal carrier) printed on white substrate may be difficult to copy, yet the digital watermark is still detectable in the original since the ink and paper have a reflectivity difference (e.g., 8-25% reflectivity difference). This may result since white paper includes a brightener that is brighter than the white ink. This reflectivity difference may become eroded in a copy since the white ink and paper brightener may change.

Use of multiple digital watermarks (e.g., 1 covert+1 overt) as method for copy detection. For example, a digital watermark is applied using standard process color inks alongside a digital watermark in printed varnish or printed white-on-white. The varnish or white ink digital watermark is more “covert” relative to the standard process color inks. In certain counterfeit workflows, the covert marks may not be reliably reproduced, and the absence of this suggests a copy.

Color changes when conveying a digital watermark. Consider a sparse mark 2D pattern. The 2D pattern of dots can be printed with a color gradient from left to right (e.g., think rainbow of dots). Some of these colors can be printed using so-called out-of-gamut inks. That is, inks that are hard to reproduce using standard process color inks.

Weak Watermarks applied using Cyan, Magenta, Yellow and/or Black (K). A digital watermark can be designed to include weak detectability measures. For example, the digital watermark can be designed so that its detectability measures, e.g., as described in assignee U.S. Pat. No. 11,188,997, are right on a threshold of detection. Reproduction of such a weak digital watermark is difficult, especially on lower-end consumer printers/scanners.

As mentioned in the beginning of this Implementation V, one or more of these security features can be combined with other such features from Implementations I-V.

### IV. Example Combinations of Features

Without limiting the scope of the appended claims, the following combinations of features are provided as non-limiting examples that demonstrate specific arrangements and aspects of the present disclosure. Of course, other combinations will be readily apparent from the written description and drawings.

A1. An image processing method for authenticating a printed document comprising: obtaining a captured image depicting a printed document, the printed document comprising a digital watermark component and an embedded auxiliary signal, wherein the digital watermark component includes a synchronization component associated with a first set of frequencies, and wherein the embedded auxiliary signal is associated with a second set of frequencies that are higher frequencies relative to the first set of frequencies; detecting the synchronization component in the captured image; determining orientation parameters of the captured image based on the synchronization component; transforming an image block or signal tile extracted from the captured image into a frequency domain, said transforming yielding a transformed image block; orienting the transformed image block to a refined reference frame based on determined orientation parameters; in the refined reference frame, determining magnitude values at specific frequency locations associated with the second set of frequencies; comparing determined magnitude values with comparison values; and authenticating the printed document as an original or identifying the printed document as a copy based on said comparing.

A2. The method of A1, wherein the auxiliary signal comprises between 4 and 24 additional signals, each with expected Fourier domain characteristics.

A3. The method of A1, wherein the auxiliary signal is embedded at frequency locations that are harmonics of the synchronization component.

A4. The method of A1, further comprising: refining the determined orientation parameters using a least squares adjustment to yield a refined transformation; wherein said orienting the transformed image block to a refined reference frame is based on the refined transformation.

A5. The method of A4, wherein said comparing the determined magnitude values with comparison values comprises a comparison of the magnitude values of the second set of frequencies to magnitude values of the first set of frequencies obtained from the refined reference frame.

A6. The method of A1, further comprising: identifying a fidelity point in the captured image, the fidelity point indicating an image area having a likelihood of success for signal detection; and extracting the image block from the identified fidelity point.

A7. The method of A1, wherein transforming the image block comprises performing a two-dimensional Fast Fourier Transform (FFT) on the image block.

A8. The method of A7, further comprising performing a complex bilinear interpolation of the FFT to refine frequency results.

A9. The method of A1, wherein comparing the determined magnitude values with comparison comprises: providing the determined magnitude values and determined magnitude values of the first set of frequencies obtained from the refined reference frame to a trained classifier; and receiving from the trained classifier a determination of whether the printed document is an original or a copy.

A10. The method of A9, wherein the trained classifier is selected from the group consisting of: a Gradient Boosting Classifier, a Logistic Regression classifier, a Support Vector Machine, a Naive Bayes classifier, and a Quadratic Discriminant Analysis classifier.

A11. The method of A1, wherein comparing the determined magnitude values with comparison data comprises at least one of: performing a threshold comparison to determine whether the magnitude values at high-frequency locations exceed a predetermined threshold; performing a relative comparison by comparing a ratio of frequency amplitudes of the second set of frequencies to amplitudes of the first set of frequencies from the frame of reference; performing a pattern analysis by examining a pattern of attenuation across multiple high-frequency locations; performing a statistical analysis by applying statistical tests to a distribution of high-frequency components; and pattern matching in the frequency domain for a pattern formed by the second set of frequencies.

A12. The method of A1 in which the synchronization component comprises sine waves with pseudo-random phase that appear as peaks in a Fourier domain, and where said auxiliary signal comprises at least one of: sine waves, cosine waves, a sum of complex exponentials, modulated carrier waves, or data arranged via 2D Fourier transform of images.

A13. The method of A1, wherein the auxiliary signal is arranged to form a pattern in the Fourier domain, the pattern being selected from the group consisting of: a circle, an oval, and a predetermined pattern shape.

A14. The method of A1, wherein the number of frequency domain points for measurement of the auxiliary signal is equal to or between 8 and 24 points.

A15. The method of A1, wherein the auxiliary signal is embedded in digital artwork representing the printed document by at least one of: modulating line art features at high frequencies, adding high-frequency texture patterns to image areas, embedding signals in halftone screens, and modifying edge characteristics of text or graphical elements.

A16. The method of A1, further comprising: summing magnitude values at specific frequency locations in the refined reference frame; comparing the sum to a threshold value; and identifying the printed document as a copy if the sum is below the threshold value.

A17. The method of A1, further comprising: averaging or normalizing the magnitude values at specific frequency locations to produce a normalized value; comparing the normalized value against an established value associated with an original document; and determining the printed document is a counterfeit if the normalized value differs from the established value by more than a predetermined percentage or amount.

A18. The method of A4, further comprising: detecting a plurality of noise frequencies from the captured image that have been embedded in digital artwork representing the printed document, wherein the plurality of noise frequencies are in addition to the second set of frequencies associated with the auxiliary signal and the first set of frequencies associated with the synchronization component; evaluating magnitude values of the noise frequencies in the refined frame of reference; and adjusting the magnitude values of the auxiliary signal and magnitude values of the synchronization component to account for a noisy channel based on the evaluated noise frequency values.

A19. The method of A1, wherein if no digital watermark is detected, the method terminates with a determination that the printed document is a copy.

A20. The method of A1, wherein the image block has a size selected from the group consisting of: 64×64 pixels, 128×128 pixels, and 256×256 pixels.

A21. The method of A1, further comprising: verifying a digital watermark payload against expected values; and determining the printed document is authentic only when both the digital watermark payload verification and the comparison of magnitude values indicate an original document.

A22. The method of A1, wherein the auxiliary signal comprises components that are integrated into or are otherwise combined with the synchronization component.

A23. The method of A1, wherein the expected values for an original document are determined relative to one or more Fourier domain locations of the synchronization component.

A24. The method of A1, wherein the expected values for an original document are based on original placement of the auxiliary signal for a particular printed document.

A25. The method of A1, further comprising: performing quality assessment of the captured image; and proceeding with authentication only if the captured image meets predetermined quality criteria.

A26. The method of A1, wherein the captured image is obtained using an imaging device with sufficient resolution to preserve high-frequency components present in an original document.

A27. The method of A1, wherein the auxiliary signal comprises a plurality of components, each component having a different frequency characteristic.

A28. The method of A1, wherein the trained classifier is trained using: a dataset of both original documents and copies captured using an expected type or class of imaging devices; feature vectors extracted from each image in the dataset, including frequency magnitude values of both the synchronization component and the auxiliary signal; and labels indicating whether each image in the dataset represents an original document or a copy.

A29. The method of A1, wherein the auxiliary signal is embedded at frequency locations that are selected to be particularly susceptible to attenuation during a copying process.

A30. The method of A1, further comprising: determining an estimated linear transform to predict expected values of the auxiliary signal at the high frequency locations; and comparing the determined magnitude values with the predicted expected values.

A31. The method of A1, wherein the auxiliary signal is embedded in the original digital artwork at frequencies selected to be attenuated when the printed document is optically captured and reprinted using a low-resolution printer.

A32. The method of A1, wherein the specific frequency locations in the frequency domain are determined based on information provided by the digital watermark detector regarding likely signal locations within the captured image.

B1. A system for authenticating a printed document, the system comprising: an imaging device configured to capture an image depicting a printed document, the printed document comprising a digital watermark component and an embedded auxiliary signal, wherein the digital watermark component includes a synchronization component associated with a first set of frequencies, and wherein the embedded auxiliary signal is associated with a second set of frequencies that are higher frequencies relative to the first set of frequencies; a processor; and a memory storing instructions that, when executed by the processor, cause the system to: detect the synchronization component in the captured image; determine orientation parameters of the captured image based on the synchronization component; transform an image block or signal tile extracted from the captured image into a frequency domain, said transforming yielding a transformed image block; orient the transformed image block to a refined reference frame based on determined orientation parameters; in the refined reference frame, determine magnitude values at specific frequency locations associated with the second set of frequencies; compare determined magnitude values with comparison values; and authenticate the printed document as an original or identify the printed document as a copy based on said comparing.

B2. The system of B1, wherein the auxiliary signal comprises between 4 and 24 additional signals, each with expected Fourier domain characteristics.

B3. The system of B1, wherein the auxiliary signal is embedded at frequency locations that are harmonics of the synchronization component.

B4. The system of B1, wherein the instructions further cause the system to: refine the determined orientation parameters using a least squares adjustment to yield a refined transformation; wherein said orienting the transformed image block to a refined reference frame is based on the refined transformation.

B5. The system of B4, wherein said comparing the determined magnitude values with comparison values comprises a comparison of the magnitude values of the second set of frequencies to magnitude values of the first set of frequencies obtained from the refined reference frame.

B6. The system of B1, wherein the instructions further cause the system to: identify a fidelity point in the captured image, the fidelity point indicating an image area having a likelihood of success for signal detection; and extract the image block from the identified fidelity point.

B7. The system of B4, wherein the instructions further cause the system to: detect a plurality of noise frequencies from the captured image that have been embedded in digital artwork representing the printed document, wherein the plurality of noise frequencies is in addition to the second set of frequencies associated with the auxiliary signal and the first set of frequencies associated with the synchronization component; evaluate magnitude values of the noise frequencies in the refined frame of reference; and adjust the magnitude values of the auxiliary signal and magnitude values of the synchronization component to account for a noisy channel based on the evaluated noise frequency values.

B8. The system of B1, wherein transforming the image block comprises performing a two-dimensional Fast Fourier Transform (FFT) on the image block.

B9. The system of B8, wherein the instructions further cause the system to perform a complex bilinear interpolation of the FFT to refine frequency results.

B10. The system of B1, wherein comparing the determined magnitude values with comparison values comprises: providing the determined magnitude values and determined magnitude values of the first set of frequencies obtained from the refined reference frame to a trained classifier; and receiving from the trained classifier a determination of whether the printed document is an original or a copy.

C1. A system for authenticating a printed document, the system comprising: means for capturing an image depicting a printed document, the printed document comprising a digital watermark component and an embedded auxiliary signal, wherein the digital watermark component includes a synchronization component associated with a first set of frequencies, and wherein the embedded auxiliary signal is associated with a second set of frequencies that are higher frequencies relative to the first set of frequencies; means for detecting the synchronization component in the captured image; means for determining orientation parameters of the captured image based on the synchronization component; means for transforming an image block or signal tile extracted from the captured image into a frequency domain, said transforming yielding a transformed image block; means for orienting the transformed image block to a refined reference frame based on determined orientation parameters; means for determining, in the refined reference frame, magnitude values at specific frequency locations associated with the second set of frequencies; means for comparing determined magnitude values with comparison values; and means for authenticating the printed document as an original or identifying the printed document as a copy based on said comparing.

D1. A non-transitory computer-readable medium storing instructions that, when executed by a processor, cause the processor to perform a method for authenticating a printed document, the method comprising: obtaining a captured image depicting a printed document, the printed document comprising a digital watermark component and an embedded auxiliary signal, wherein the digital watermark component includes a synchronization component associated with a first set of frequencies, and wherein the embedded auxiliary signal is associated with a second set of frequencies that are higher frequencies relative to the first set of frequencies; detecting the synchronization component in the captured image; determining orientation parameters of the captured image based on the synchronization component; transforming an image block or signal tile extracted from the captured image into a frequency domain, said transforming yielding a transformed image block; orienting the transformed image block to a refined reference frame based on determined orientation parameters; in the refined reference frame, determining magnitude values at specific frequency locations associated with the second set of frequencies; comparing determined magnitude values with comparison values; and authenticating the printed document as an original or identifying the printed document as a copy based on said comparing.

E1. A printed object comprising: a substrate; a print element printed on the substrate using an Optical Variable Ink (OVI), the print element including a plurality of holes arranged according to an encoded signal pattern, wherein the OVI displays at least two distinct colors depending on viewing angle; and wherein the plurality of holes creates a reflectivity contrast difference between the holes and the OVI print element that is detectable by a signal detector to extract a plural-bit message carried by the encoded signal pattern.

E2. The printed object of E1, wherein the plurality of holes has sizes ranging from 0.1 mm to 0.2 mm.

E3. The printed object of E1, wherein the reflectivity contrast difference between the holes and the OVI print element is between 12% and 25%.

E4. The printed object of E1, wherein the holes are filled with a color ink or topcoat that maintains a detectable reflectivity difference relative to the OVI print element.

E5. The printed object of E1, wherein the encoded signal pattern comprises a sparse mark digital watermark signal.

F1. A printed object comprising: a substrate; and printing on the substrate arranged in a two-dimensional pattern to convey a digital watermark signal comprising a plural-bit payload, the printing comprising a mixture of white ink and varnish, wherein the mixture comprises 55%-70% by weight or volume of white ink and 45%-30% by weight or volume of varnish, wherein under white light illumination, the mixture appears lighter relative to the substrate, and wherein under ultraviolet (UV) illumination, the mixture appears darker relative to the substrate, creating a digital watermark signal polarity shift.

F2. The printed object of F1, wherein the varnish comprises gloss varnish.

F3. The printed object of F1, wherein the mixture creates a reflectivity difference relative to the substrate of between 12% and 25% under white light illumination.

F4. The printed object of F1, wherein the UV illumination comprises a wavelength between 300 nm and 400 nm.

F5. The printed object of F1, wherein the two-dimensional pattern comprises a sparse mark digital watermark pattern.

G1. A security document comprising: a substrate; a hologram applied to the substrate; and an encoded signal printed over the hologram using yellow ink arranged in a pattern of dots, wherein the encoded signal carries a plural-bit message, and wherein reflectivity of the yellow ink dots changes as viewing angle changes, creating a contrast between the dots and the hologram that varies at different viewing angles.

G2. The security document of G1, wherein the dots have sizes ranging from 0.1 mm to 0.2 mm.

G3. The security document of G1, wherein the encoded signal comprises a sparse mark digital watermark signal.

G4. The security document of G1, wherein the hologram comprises a color-shifting hologram that displays different colors at different viewing angles.

G5. The security document of G1, wherein the security document is configured to be authenticated by comparing signal detection metrics measured at different viewing angles.

H1. A method for authenticating a printed object, the method comprising: capturing an image of a printed object having a digital watermark signal printed thereon; detecting the digital watermark signal in the captured image; decoding a payload from the detected digital watermark signal; querying a data repository with the decoded payload to obtain a stored fingerprint associated with the payload, wherein the stored fingerprint characterizes print structures that represent the digital watermark signal; generating a fingerprint of print elements conveying the digital watermark from the captured image; and determining authenticity of the printed object by comparing the generated fingerprint with the stored fingerprint.

H2. The method of H1, wherein the fingerprint characterizes at least one of: size, shape, edginess, and relative positioning of the print structures.

H3. The method of H1, further comprising: using a synchronization component of the digital watermark to resize the captured image to a base state before generating the fingerprint.

H4. The method of H1, further comprising: comparing detection metrics associated with the detected digital watermark signal with stored original detection metrics; and determining the printed object is counterfeit when the detection metrics differ from the original detection metrics by more than 10%.

H5. The method of H1, wherein the digital watermark signal comprises a sparse mark digital watermark signal.

I1. A method for authenticating a printed object, the method comprising: capturing an image of a printed object; detecting a first digital watermark signal in the captured image under a first illumination condition; detecting a second digital watermark signal in the captured image under a second illumination condition different from the first illumination condition; decoding a first payload from the first digital watermark signal; decoding a second payload from the second digital watermark signal; determining whether the first payload and second payload are related according to a predetermined relationship; and authenticating the printed object based on the determination.

I2. The method of I1, wherein the first digital watermark signal is printed using process color inks and the second digital watermark signal is printed using one of: varnish, white ink on white substrate, ultraviolet (UV) ink, infrared (IR) ink, or optically variable ink (OVI).

I3. The method of I1, wherein the second illumination condition comprises ultraviolet illumination.

I4. The method of I1, further comprising: communicating at least one of the first payload or second payload to an online repository; receiving information indicating an expected distribution channel for the printed object; and determining the printed object is counterfeit when a current location of the printed object does not match the expected distribution channel.

I5. The method of I1, wherein determining whether the first payload and second payload are related comprises determining whether one payload serves as a decryption key for the other payload.

J1. A method for predicting digital watermark robustness on a substrate, the method comprising: measuring a gloss value of a substrate having a varnish applied thereto in a pattern representing a digital watermark signal; measuring a gloss value of the bare substrate without the varnish; determining a gloss contrast between the varnish and the bare substrate; and predicting robustness of the digital watermark signal based on the determined gloss contrast.

K1. A system for authenticating a printed object, the system comprising: a camera configured to capture imagery depicting a printed object having a first digital watermark signal printed with process color inks and a second digital watermark signal printed with a covert material selected from the group consisting of: varnish, white ink on white substrate, ultraviolet (UV) ink, infrared (IR) ink, and optically variable ink (OVI); a processor; and a memory storing instructions that, when executed by the processor, cause the system to: detect the first digital watermark signal in the captured imagery; detect the second digital watermark signal in the captured imagery; determine whether both digital watermark signals are present; and authenticate the printed object as an original only when both digital watermark signals are detected.

L1. A method for authenticating a printed object, the method comprising: capturing an image of a printed object having a digital watermark signal printed thereon using a mixture of white ink and varnish; illuminating the printed object with ultraviolet (UV) light having a wavelength between 300 nm and 400 nm; capturing a second image of the printed object under the UV illumination; detecting a first signal polarity of the digital watermark signal in the first captured image, wherein the mixture appears lighter than the substrate under normal illumination; detecting a second signal polarity of the digital watermark signal in the second captured image, wherein the mixture appears darker than the substrate under UV illumination; and authenticating the printed object as an original only when both the first signal polarity and the second signal polarity are successfully detected.

M1. An image processing method for authenticating a value document comprising: obtaining an image depicting a value document, in which the value document comprises a substrate comprising printing thereon, in which the printing comprises a line art feature comprising a plurality of lines associated with one or more line frequencies, the line art feature comprising an encoded signal carried by modulations to the plurality of lines, in which the encoded signal comprises a synchronization component and a message component, and in which the printing is printed with a first spot color ink; analyzing the image to decode the message component from the encoded signal, the message component indicating data associated with expected frequency domain locations one or more line frequencies; transforming the image into a frequency domain and determining frequency domain locations for the one or more line frequencies in the frequency domain; and determining whether one or more frequency domain locations of the one or more expected line frequencies and one or more frequency domain locations of the determined one or more line frequencies coincide.

M2. The image processing method of M1 in which further comprising, and prior to said transforming the image into a frequency domain, filtering the image to remove image content.

M3. The image processing method of M1 further comprising, and prior to said transforming the image into a frequency domain, rotating the image relative to an expected orientation based on the synchronization component.

M4. The image processing method of M1 further comprising, and prior to said transforming the image into a frequency domain, determining a scale relative to an expected orientation based on the synchronization component, in which the location of the one or more line frequencies are determined relative to the scale.

M5. The image processing method of M1 further comprising: in the frequency domain, determining presence or absence of halftoning.

M6. The image processing method of M1 further comprising: determining that the value document is authentic upon: i) successful decoding of the encoded signal, and ii) determining that the one or more frequency domain locations of the one or more expected line frequencies and the one or more frequency domain locations of the determined one or more line frequencies coincide.

M7. The image processing method of M5 further comprising: determining that the value document is authentic upon: i) successful decoding of the encoded signal, and ii) determining that the one or more frequency domain locations of the one or more expected line frequencies and the one or more frequency domain locations of the determined one or more line frequencies coincide, and iii) determining the absence of halftoning.

M8. The image processing method of M1, in which the message component comprises or is an index for expected color data associated with the first spot color ink, said method further comprising: obtaining color data from an image sensor; and determining whether the obtained color data coincides with the expected color data.

M9. The image processing method of M8 further comprising: determining that the value document is authentic upon: successful decoding of the encoded signal, and determining that the one or more frequency domain locations of the one or more expected line frequencies and the one or more frequency domain locations of the determined one or more line frequencies coincide, and iii) determining that the obtained color data coincides with the expected color data.

M10. The image processing method of M8 further comprising: in the frequency domain, determining presence or absence of halftoning; determining that the value document is authentic upon: i) successful decoding of the encoded signal, and ii) determining that the one or more frequency domain locations of the one or more expected line frequencies and the one or more frequency domain locations of the determined one or more line frequencies coincide, and iii) determining the absence of halftoning, and iv) determining that the obtained color data coincides with the expected color data.

M11. The image processing method of M1 further comprising: from a frequency domain, collecting input variables associated with the one or more line frequencies, and providing the collected input variables to a trained classifier to determine a classification value.

M12. The image processing method of M11 in which the collected input variables are also associated with the synchronization component.

M13. The image processing method of M11 or M12 further comprising: determining that the value document is authentic upon: i) successful decoding of the encoded signal, and ii) determining that the one or more frequency domain locations of the one or more expected line frequencies and the one or more frequency domain locations of the determined one or more line frequencies coincide, and iii) receiving a determine classification value indicating an original.

M14. An apparatus comprising: a camera; a display; one or more processors; and memory storing instructions therein that, when executed by said one or more processors, cause said apparatus to perform the method of any one of M1-M13.

M15. The apparatus of M14 in which said apparatus comprises a smartphone having an app stored therein, in which the app comprises the instructions.

M16. A non-transitory computer readable medium comprising instructions stored thereon that, when executed by one or more processors of a computer system, cause the computer system to perform the methods of anyone of M1-M13.

### V. Operating Environments

The components and operations of the various described embodiments and implementations shown in figures and/or discussed in text above, can be implemented in modules. Notwithstanding any specific discussion of the embodiments set forth herein, the term “module” and “app” may refer to software, firmware and/or circuitry configured to perform any of the methods, processes, algorithms, functions or operations described herein. Software may be embodied as a software package, executable code, instructions, instruction sets, or data recorded on non-transitory computer readable storage mediums. Software instructions for implementing the detailed functionality can be authored by artisans without undue experimentation from the descriptions provided herein, e.g., written in Swift, Objective-C, C, C++, C#, Ruby, MatLab, Visual Basic, Java, Python, Tcl, Perl, Scheme, and assembled in executable binary files, etc., in conjunction with associated data. Firmware may be embodied as code, instructions or instruction sets or data that are hard-coded (e.g., nonvolatile) in memory devices. As used herein, the term “circuitry” may include, for example, singly or in any combination, hardwired circuitry, programmable circuitry such as one or more computer processors comprising one or more individual instruction processing cores, parallel processors, multi-core processors, state machine circuitry, or firmware that stores instructions executed by programmable circuitry.

Applicant's work also includes taking the scientific principles and natural laws on which the present technology rests and tying them down in particularly defined implementations. One such realization of such implementations is electronic circuitry that has been custom-designed and manufactured to perform some or all of the component acts, as an application specific integrated circuit (ASIC).

To realize such implementations, some or all of the technology is first implemented using a general-purpose computer, using software such as MatLab (from MathWorks, Inc.). A tool such as HDLCoder (also available from Math Works) is next employed to convert the MatLab model to VHDL (an IEEE standard, and doubtless the most common hardware design language). The VHDL output is then applied to a hardware synthesis program, such as Design Compiler by Synopsis, HDL Designer by Mentor Graphics, or Encounter RTL Compiler by Cadence Design Systems. The hardware synthesis program provides output data specifying a particular array of electronic logic gates that will realize the technology in hardware form, as a special-purpose machine dedicated to such purpose. This output data is then provided to a semiconductor fabrication contractor, which uses it to produce the customized silicon part. (Suitable contractors include TSMC, Global Foundries, and ON Semiconductors.)

The modules, apps, methods, processes, components, technology, apparatus and systems described above may be implemented in hardware, software or a combination of hardware and software. For example, the authentication checks for value documents discussed above in Section II may be implemented in software (e.g., embodied in an app or module), firmware, hardware, combinations of software, firmware and hardware, and/or combinations of software and/or software instructions executing on a programmable computer, electronic processing circuitry, CPUs (Central Processing Units), GPUs (Graphics Processing Units), TPUs (Tensor Processing Units, developed by Google), FPGAs (Field Programmable Gate Arrays), ASICs, digital signal processors (DSP), a programmable computer, electronic processing circuitry, and/or by executing software or software instructions with a one or more processors including one or more parallel processors, one or more multi-core processor(s) and/or other multi-processor configurations.

### CONCLUDING REMARKS

Having described and illustrated the principles of the technology with reference to specific implementations, it will be recognized that the technology can be implemented in many other, different, forms. To provide a comprehensive disclosure without unduly lengthening the specification, applicant hereby incorporates by reference each of the above-mentioned patent documents in its entirety.

The particular combinations of elements and features in the above-detailed embodiments are exemplary only; the interchanging and substitution of these teachings with other teachings in this and the incorporated-by-reference patents and documents are also contemplated.

1. An image processing method for authenticating a printed document comprising:
obtaining a captured image depicting a printed document, the printed document comprising a digital watermark component and an embedded auxiliary signal, wherein the digital watermark component includes a synchronization component associated with a first set of frequencies, and wherein the embedded auxiliary signal is associated with a second set of frequencies that are higher frequencies relative to the first set of frequencies;
detecting the synchronization component in the captured image;
determining orientation parameters of the captured image based on the synchronization component;
transforming an image block or signal tile extracted from the captured image into a frequency domain, said transforming yielding a transformed image block;
orienting the transformed image block to a refined reference frame based on determined orientation parameters;
in the refined reference frame, determining magnitude values at specific frequency locations associated with the second set of frequencies;
comparing determined magnitude values with comparison values; and
authenticating the printed document as an original or identifying the printed document as a copy based on said comparing.

2. The image processing method of claim 1, wherein the embedded auxiliary signal comprises between 4 and 24 additional signals, each with expected Fourier domain characteristics.

3. The image processing method of claim 1, further comprising:
refining the determined orientation parameters using a least squares adjustment to yield a refined transformation; wherein said orienting the transformed image block to a refined reference frame is based on the refined transformation.

4. The image processing method of claim 3, wherein said comparing the determined magnitude values with comparison values comprises a comparison of the magnitude values of the second set of frequencies to magnitude values of the first set of frequencies obtained from the refined reference frame.

5. The image processing method of claim 1, further comprising:
identifying a fidelity point in the captured image, the fidelity point indicating an image area having a likelihood of success for signal detection, said identifying yielding an identified fidelity point; and
extracting the image block from the identified fidelity point.

6. The image processing method of claim 1, wherein transforming the image block comprises performing a two-dimensional Fast Fourier Transform (FFT) on the image block.

7. The image processing method of claim 6, further comprising performing a complex bilinear interpolation of the FFT to refine frequency results.

8. The image processing method of claim 1, wherein comparing the determined magnitude values with comparison comprises:
providing the determined magnitude values and determined magnitude values of the first set of frequencies obtained from the refined reference frame to a trained classifier; and
receiving from the trained classifier a determination of whether the printed document is the original or the copy.

9. The image processing method of claim 8, wherein the trained classifier is selected from a group consisting of: a Gradient Boosting Classifier, a Logistic Regression classifier, a Support Vector Machine, a Naive Bayes classifier, and a Quadratic Discriminant Analysis classifier.

10. The image processing method of claim 1, wherein comparing the determined magnitude values with comparison data comprises at least one of:
performing a threshold comparison to determine whether the magnitude values at high-frequency locations exceed a predetermined threshold;
performing a relative comparison by comparing a ratio of frequency amplitudes of the second set of frequencies to amplitudes of the first set of frequencies from the refined reference frame;
performing a pattern analysis by examining a pattern of attenuation across multiple high-frequency locations;
performing a statistical analysis by applying statistical tests to a distribution of high-frequency components; and
pattern matching in the frequency domain for a pattern formed by the second set of frequencies.

11. The image processing method of claim 1 in which the synchronization component comprises sine waves with pseudo-random phase that appear as peaks in a Fourier domain, and where said auxiliary signal comprises at least one of: sine waves, cosine waves, a sum of complex exponentials, modulated carrier waves, or data arranged via 2D Fourier transform of images.

12. The image processing method of claim 1, wherein the embedded auxiliary signal is embedded in digital artwork representing the printed document by at least one of: modulating line art features at high frequencies, adding high-frequency texture patterns to image areas, embedding signals in halftone screens, and modifying edge characteristics of text or graphical elements.

13. The image processing method of claim 1, further comprising:
summing magnitude values at specific frequency locations in the refined reference frame to yield a sum;
comparing the sum to a threshold value; and
identifying the printed document as the copy if the sum is below the threshold value.

14. The image processing method of claim 1, further comprising:
averaging or normalizing the magnitude values at specific frequency locations to produce a normalized value;
comparing the normalized value against an established value associated with an original document; and
determining the printed document is a counterfeit if the normalized value differs from the established value by more than a predetermined percentage or amount.

15. The image processing method of claim 3, further comprising:
detecting a plurality of noise frequencies from the captured image that have been embedded in digital artwork representing the printed document, wherein the plurality of noise frequencies is in addition to the second set of frequencies associated with the embedded auxiliary signal and the first set of frequencies associated with the synchronization component;
evaluating magnitude values of the plurality of noise frequencies in the refined reference frame; and
adjusting the magnitude values of the embedded auxiliary signal and magnitude values of the synchronization component to account for a noisy channel based on evaluated noise frequency values.

16. An image processing method for authenticating a value document comprising:
obtaining an image depicting a value document, in which the value document comprises a substrate comprising printing thereon, in which the printing comprises a line art feature comprising a plurality of lines associated with one or more line frequencies, the line art feature comprising an encoded signal carried by modulations to the plurality of lines, in which the encoded signal comprises a synchronization component and a message component, and in which the printing is printed with a first spot color ink;
analyzing the image to decode the message component from the encoded signal, the message component indicating data associated with expected frequency domain locations of one or more line frequencies;
transforming the image into a frequency domain, and determining frequency domain locations for the one or more line frequencies in the frequency domain, said determining frequency domain locations yielding determined locations of the one or more line frequencies; and
determining whether one or more of the expected frequency domain locations of the one or more line frequencies and one or more frequency domain locations of the determined locations of the one or more line frequencies coincide.

17. The image processing method of claim 16, in which the message component comprises or is an index for expected color data associated with the first spot color ink, said method further comprising:
obtaining color data from an image sensor;
determining whether the obtained color data coincides with the expected color data; and
determining that the value document is authentic upon:
i) successful decoding of the encoded signal, and
ii) determining that the one or more frequency domain locations of the one or more expected line frequencies and the one or more frequency domain locations of the determined one or more line frequencies coincide, and
iii) determining that the obtained color data coincides with the expected color data.

18. The image processing method of claim 17 further comprising:
in the frequency domain, determining presence or absence of halftoning;
determining that the value document is authentic upon: i) successful decoding of the encoded signal, and ii) determining that the one or more frequency domain locations of the one or more expected line frequencies and the one or more frequency domain locations of the determined one or more line frequencies coincide, and iii) determining the absence of halftoning, and iv) determining that the obtained color data coincides with the expected color data.

19. The image processing method of claim 17 further comprising:
from the frequency domain, collecting input variables associated with the one or more line frequencies, and providing collected input variables to a trained classifier to determine a classification value.

20. A printed object comprising:
a substrate; and
printing on the substrate, the printing arranged in a 2D pattern to convey a digital watermark signal, the digital watermark signal comprising a plural-bit payload, the printing comprising a white ink/gloss varnish mixture, in which the white ink/gloss varnish mixture comprises 55%-70% by volume or weight of white ink and 45%-30% by volume or weight of gloss varnish, in which under white light or ambient illumination, a layer of white ink/gloss varnish mixture/substrates appears lighter than the substrate, and in which under ultraviolet illumination, the layer of white ink/gloss varnish mixture/substrates appears darker relative to the substrate,
wherein the digital watermark signal comprises a signal polarity, and under white light or ambient illumination, the digital watermark signal is interpreted as positive polarity, and under ultraviolet illumination the digital watermark signal is interpreted as negative polarity.
